(19) United States
(12) Patent Application Publication
(10) Pub. No.: US 2001/0051086 A1
(43) Pub. Date: Dec. 13, 2001

(54) Automated feed mechanism for electronic components of silicon wafer

(76) Inventors: Brian Blades, Concord, NH (US); Rodney P. Jackson, Auburn, NH (US); James L. Dowling, Milford, NH (US); Lawrence F. Roberts, Londonderry, NH (US)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/804,790

(22) Filed: Mar. 13, 2001

Related U.S. Application Data
(60) Provisional application No. 60/188,718, filed on Mar. 13, 2000.

(51) Int. Cl. B65G 1/10

(52) U.S. Cl. 414/331.14; 414/416.03; 414/416.08; 118/500; 414/937; 414/758

(57) ABSTRACT

An automated feed mechanism (2) for retrieving a desired wafer assembly (20). The automated feed mechanism (2) has an elevator assembly (12) for storing a plurality of wafer assemblies (20) and the elevator assembly (12) is driven to facilitate retrieval of the desired wafer assembly (20). A pick and place assembly (16) retrieves electronic components (22), from a retrieved wafer assembly (20), and transports each retrieved electronic component (22) to a shuttle assembly (18). The shuttle assembly (18) comprises first and second shuttle platforms (34, 36), with one of the shuttle platforms (34 or 36) located adjacent the pick and place assembly (16) for loading electronic components (22) thereon, and the second shuttle platform (36 or 34) located at a dispensing position (D) for retrieval of the previously loaded electronic components (22) by an automated assembly machine (3). An inverter assembly (15) may be provided for inverting the electronic components, received from the pick and place assembly (16), prior to transferring the retrieved electronic components (22 to the shuttle assembly (18).

### FIELD OF THE INVENTION

The present invention relates to an automated feed mechanism for sequentially feeding electronic components, from a wafer to a host machine, e.g. an automated assembly apparatus, for manufacture of the electronic components into a desired product.

### BACKGROUND OF THE INVENTION

As is conventional in the prior art, a wafer, e.g. a silicon wafer, is affixed to an adherent film to facilitate handling of the wafer and removal of the various electronic components forming the wafer. A free perimeter portion of the adherent film, sufficiently spaced from the silicon wafer supported thereon, is supported by a perimeter film frame and the film frame maintains the adherent film in a generally planar configuration. The film frame, the adherent film and the wafer all form a component commonly referred to as a “wafer assembly”. The film frame facilitates transportation and handling of the wafer so that the various electronic components comprising the wafer can be readily separated, from the adherent film, and utilized to manufacture desired components.

One problem with conventional prior art feed mechanisms is that they are typically employ a “single shuttle” assembly which limits the retrieval and transportation capacity of the feed mechanism. The single shuttle assembly supports a group of vacuum operated ports that are first populated, at a loading area, by a pick and place mechanism and then, once each one of the group of vacuum ports is sufficiently populated with a desired electronic component, the single shuttle is conveyed to a dispensing area where an automated assembly apparatus will utilize and deplete the populated individual electronic components as required. Once the electronic components are depleted, the single shuttle is then reconveyed back to the loading position for repopulation by the pick and place mechanism of the automated feed mechanism. Accordingly, while the single shuttle is being repopulated by the pick and place mechanism, the automated assembly apparatus is typically in a standby or idle mode awaiting a supply of additional individual electronic components to be furnished by the single shuttle. This standby or idle mode limits the production time of the automated assembly apparatus and is to be minimized as much as possible.

### SUMMARY OF THE INVENTION

Wherefore, it is an object of the present invention to overcome the shortcomings and drawbacks associated with the prior art automated feed mechanisms.

Another object of the present invention is to provide an improved automated feed mechanism which facilitates retrieval of a desired wafer assembly, comprising a film frame supporting an adherent film having a wafer affixed thereto, from an elevator assembly, supporting a wafer assembly magazine, as well as removal and conveyance of the various electronic components, comprising the wafer, from the adherent film to a dispensing area where an automated assembly apparatus may retrieve the electronic components and assemble the same into a desired product.

A further object of the present invention to provide an automated feed mechanism which minimizes the width dimensions of the mechanism, e.g. the automated feed mechanism is no wider than about 21 inches, to facilitate a more compact system which is readily integrated with existing automated assembly apparatuses.

Still another object of the present invention is to provide an automated feed mechanism with a transportation system having the capability of removing individual electronic components from a plurality of different size wafer assemblies, e.g. 50 mm, 100 mm, 150 mm, 200 mm and/or 300 mm wafer assemblies, and supplying the removed individual electronic components to a shuttle assembly for temporary storage prior to being retrieved by an automated assembly apparatus for use in producing a desired end product.

Yet another object of the present invention is to provide an automated feed mechanism which has the capability of storing various size wafer assemblies, e.g. 50 mm, 100 mm, 150 mm, 200 mm and/or 300 mm wafer assemblies, vertically stacked in a single wafer assembly magazine and facilitate retrieval of a desired one of the stored wafer assemblies, from the wafer assembly magazine, and supply of the same to the automated feed mechanism thereby minimizing the amount of equipment required to handle and feed the wafer assemblies.

A still further object of the present invention is to minimize the amount of floor space which is occupied by the automated feed mechanism so that each wafer assembly, handled by the automated feed mechanism, can be handled within the smallest amount of floor space possible, e.g. within about 1300 square inches or less.

Yet another object of the present invention is to provide a dual shuttle mechanism which increases the throughput of the automated feed mechanism so as to minimize the standby or idle time of the automated assembly apparatus. That is, the automated feed mechanism preferably has two identical but separate spaced apart shuttle platforms which allow a first one of the shuttle platforms to be populated with desired electronic components, at a loading position, while a second one of the shuttle platforms, previously populated with electronic components, is located at a dispensing position adjacent the automated assembly apparatus where the electronic components are removed to produce a desired product. The dual shuttle mechanism facilitates virtually continuous uninterrupted feed of electronic components to the automated assembly apparatus.

Another object of the present invention is to provide a unique loading and unloading mechanism which contributes to the compact size of the automated feed mechanism by providing fewer steps and less movement of the wafer assembly from one processing step to the next.

A further object of the invention is to reduce mass of the collet pick-up assembly to increase the picking and placing speed of the collet pick-up assembly and thereby increase the overall operational speed of the automated feed mechanism. In particular, the present invention seeks to obtain a cycle time of approximately ½ seconds or so to pick an electronic component from the wafer assembly and place the same on the shuttle assembly and return the collet pick-up assembly back to the wafer assembly for retrieval of a further electronic component. It is anticipated that pick and placement of approximately 2400 or more electric components per hour is possible with the present invention.

Another object of the present invention is to provide a mechanism for adjusting the orientation of a wafer assembly, supported on the input table/ loader assembly, relative to the automatic feed mechanism to compensate for any minor misalignment of a wafer supported by the wafer assembly.

Still another object of the present invention is to provide an automated feed mechanism which can determine which wafer assembly, temporarily stored in the wafer assembly magazine, has the desired component or components to be assembled and facilitate retrieval of that desired wafer assembly from the wafer assembly magazine and conveyance of the same to the input table/loader assembly so that a desired amount of electronic components, from that wafer assembly, can be retrieved therefrom. The automated feed mechanism further facilitates the return of that partially depleted wafer assembly to the elevator assembly for temporary storage and retrieval of a further desired wafer assembly from the wafer assembly magazine for retrieval of a desired amount of other electronic component(s) therefrom during production of a desired product.

A further object of the present invention is to provide electronic gearing control technology in a computer which controls movement of various motorized components to optimize acceleration of the various components, when moving from one location to another location, and also minimizes the possibility of collisions between the various components. According to a preferred form of the invention, if a component is to be moved along two or more axes, the activated drives for that moving component are appropriately accelerated or slowed down so that all of the drives essentially commence operation, at the same time, and discontinue operation, at the same time, as soon as that the component is placed at its final destination. Such control results in a substantially linear movement of the component from one location to another location.

Still another object of the present invention is to provide an inverter assembly which facilitates receiving electronic components from the pick and place apparatus and inverting or flipping the electronic components over 180° before transferring the electronic components to either a first or a second shuttle assembly. This inverting or flipping procedure facilitates the supply of the electronic components, by the automated feed mechanism, to the automated assembly apparatus in an inverted orientation.

Yet another object of the present invention is to provide a shuttle apparatus which allows the first and second shuttle platforms to be passed one beneath the other as the first and second shuttle platforms are shuttle to and from a loading position and a dispensing position.

A still further object of the present invention is to provide a shuttle apparatus which allows the first and second shuttle platforms to be passed side by side, adjacent one another, as the first and second shuttle platforms are shuttle to and from a loading position and a dispensing position.

The present invention also relates to an automated feed mechanism for supplying electronic components via a shuttle assembly, the automatic feed mechanism comprising: a support frame; and a pick and place assembly being supported by the support frame for retrieving electronic components from a desired wafer assembly and for transporting each retrieved electronic component to a shuffle assembly supported by the support frame; wherein the shuttle assembly comprises first and second shuttle platforms that are simultaneously movable with one another such that when one of the first and second shuttle platforms is moved from a loading position, located adjacent the pick and place assembly for loading of an electronic component, to a dispensing position located remote from the pick and place assembly for removal of the loaded electronic component, the other of the first and second shuttle platforms is moved from the dispensing position to the loading position.

The present invention also relates to an automated feed mechanism for a feeding wafer assembly, the automatic feed mechanism comprising: a support fame; a table/loader assembly being supported by the support frame for supporting a desired wafer assembly; and a pick and place assembly supported by the support frame means for retrieving at least one electronic component, from a supported wafer assembly and transporting the at least one retrieved electronic component to a shuttle assembly supported by the support frame; wherein the shuttle assembly comprises first and second shuttle platforms that are simultaneously movable with one another such that when one of the first and second shuttle platforms is moved from a loading position, located adjacent the pick and place assembly for loading of the at least one electronic component thereof, to a dispensing position located remote from the pick and place assembly for removal of the at least one loaded electronic component, the other of the first and second shuttle platforms is moved from the dispensing position to the loading position.

The present invention finally relates to a method of automatically feeding a wafer assembly via a automatic feed mechanism, the method comprising the steps of providing a support frame; supporting a table/loader assembly, for supporting a desired wafer assembly, on the support frame; supporting a pick and place assembly on the support frame for retrieving at least one electronic component from a supported wafer assembly and transporting each retrieved electronic component to a shuttle assembly supported by the support frame; forming the shuttle platform from the first and second shuttle platforms; and simultaneously moving the first and second shuttle platforms with one another such that when one of the first and second shuttle platforms is moved from a loading position, located adjacent the pick and place assembly for loading of the at least one electronic component thereon, to a dispensing position located remote from the pick and place assembly for removal of the loaded electronic component, the other of the first and second shuttle platforms is moved from the dispensing position to the loading position.

### BRIEF DESCRIPTION OF THE DRAWINGS

The invention will now be described, by way of example, with reference to the accompanying drawings in which:

FIG. 1 is a diagrammatic top plan view of the improved automated feed mechanism according to the present invention;

FIG. 2 is a diagrammatic side elevational view, with one of the sidewalls removed for reasons of clarity, of the improved automated feed mechanism of FIG. 1;

FIG. 3 is a diagrammatic side elevational view, similar to FIG. 2, showing a picking operation for removing one of the electronic components from a wafer assembly;

FIG. 3A is an exploded view showing a close up of the picking operation of FIG. 3;

FIG. 4 is a diagrammatic side elevational view of the shuttle assembly showing the two support platforms in first end positions;

FIG. 5 is a diagrammatic side elevational view, similar to FIG. 4, showing intermediate positions of the two shuttle platforms;

FIG. 5A is a diagrammatic top plan view of the shuttle assembly shown in FIG. 5;

FIG. 5B is a diagrammatic cross-sectional view along section line FIG. 5B-5B of FIG. 5;

FIG. 6 is a diagrammatic side elevational view, similar to FIG. 4, showing the two support platforms in second end positions;

FIG. 7 is a diagrammatic top plan view showing an intermediate position of the loader catch assembly when returning a desired wafer assembly;

FIG. 8 is an exploded diagrammatic view showing further details of the loader catch assembly of FIG. 7;

FIG. 9 is a diagrammatic cross sectional view of the input table/loader assembly;

FIG. 10 is a diagrammatic cross sectional view of the elevator assembly along section line 10-10 of FIG. 1;

FIGS. 11A-11E show the sequential movement of the loader catch assembly when conveying a wafer assembly from the input table/loader assembly to the wafer assembly magazine, following removal of the desired electronic components therefrom;

FIGS. 11F-11J show the sequential movement of the loader catch assembly when retrieving another wafer assembly from the wafer assembly magazine and conveying the retrieved wafer assembly to the input table/loader assembly;

FIG. 12 is a diagrammatic top plan view showing the X-axis range of movement of the collet pick-up assembly;

FIG. 12A is a diagrammatic front elevational view of the collet pick-up assembly of FIG. 12 shown in a completely elevated position;

FIG. 12B is a diagrammatic front elevational view of the collet pick-up assembly shown in a partially lowered position;

FIG. 12C is a diagrammatic front elevational view of the collet pick-up assembly shown in a completely lowered position;

FIG. 13 is a diagrammatic top plan view showing an embodiment of the automated feed mechanism incorporating an inverter assembly;

FIG. 13A is a diagrammatic cross sectional view of the inverter assembly of FIG. 13 along section line 13A-13A of FIG. 13;

FIG. 14 is a diagrammatic front perspective view of the inverter assembly of FIG. 13;

FIG. 14A is a diagrammatic rear perspective view of the inverter assembly of FIG. 14A;

FIG. 15 is a diagrammatic perspective view of the inverter assembly of FIG. 14A shown in the electronic component receiving position;

FIG. 15A is a diagrammatic perspective view of the inverter assembly of FIG. 14A, shown in a partially elevated position, prior to commencing rotation of the inverter platform;

FIG. 15B is a diagrammatic perspective view of the inverter assembly of FIG. 14A, shown in the maximum elevated and semi-rotated position;

FIG. 15C is a diagrammatic perspective view of the inverter assembly of FIG. 14A following completion of rotation of the inverter platform but with the inverter assembly still shown in a partially elevated position;

FIG. 15D is a diagrammatic perspective view of the inverter assembly of FIG. 14A showing the final inverted and lowered position;

FIG. 16 is a diagrammatic perspective view of the clutch member incorporated within the inverter assembly to facilitate limited vertical motion of the inverter platform;

FIG. 16A is a diagrammatic cross sectional view of the clutch member incorporated within the inverter assembly of FIG. 16 to facilitate limited vertical motion of the inverter platform;

FIG. 17 is a diagrammatic perspective view of a second embodiment of the shuttle assembly according to the present invention;

FIG. 18 is a diagrammatic perspective view of the shuttle assembly of FIG. 17, with the cam track partially visible, with the first shuttle platform shown in the loading position and the second shuttle platform shown in the dispensing position;

FIG. 18A is a diagrammatic perspective view of the shuttle assembly of FIG. 17 showing the intermediate positions of the first and second shuttle platforms where the first and second shuttle platforms are located side by side adjacent one another so as to facilitate passage; and

FIG. 18B is a diagrammatic perspective view of the shuttle assembly of FIG. 17, with the cam track partially visible, with the first shuttle platform shown in the dispensing position and the second shuttle platform shown in the loading position.

### DETAILED DESCRIPTION OF THE PRESENT INVENTION

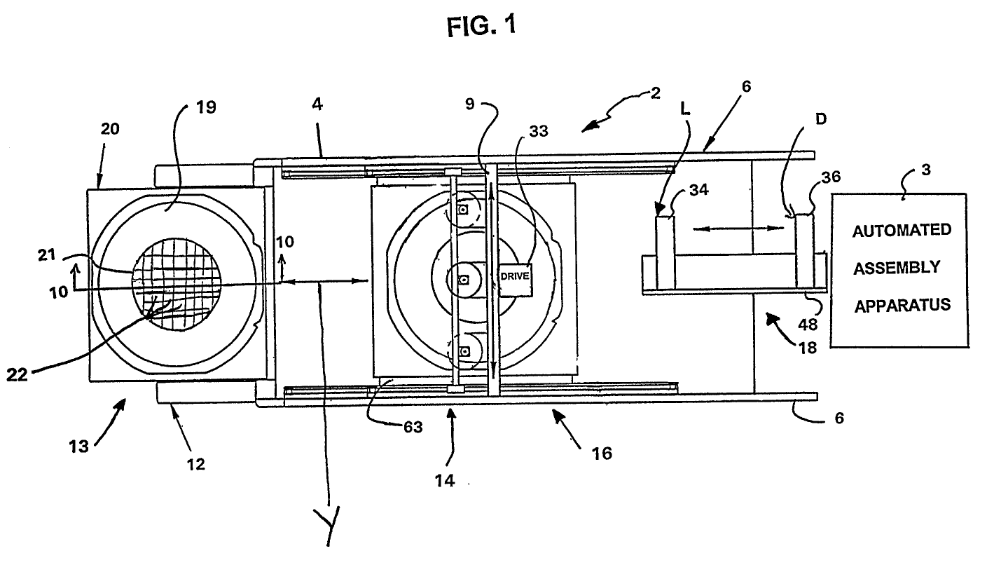

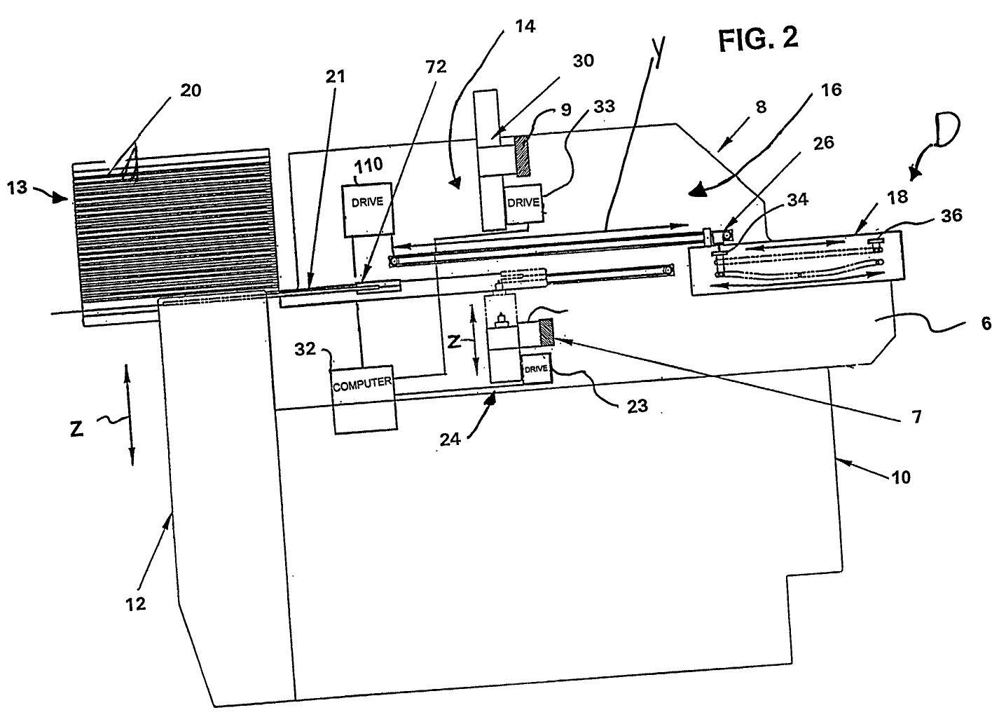

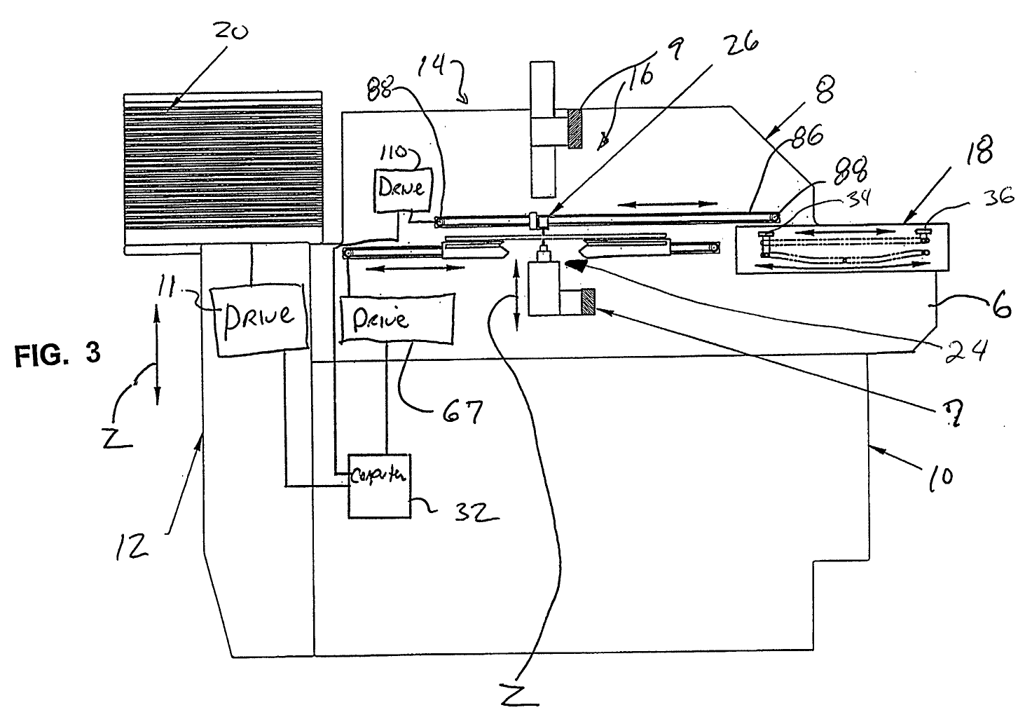

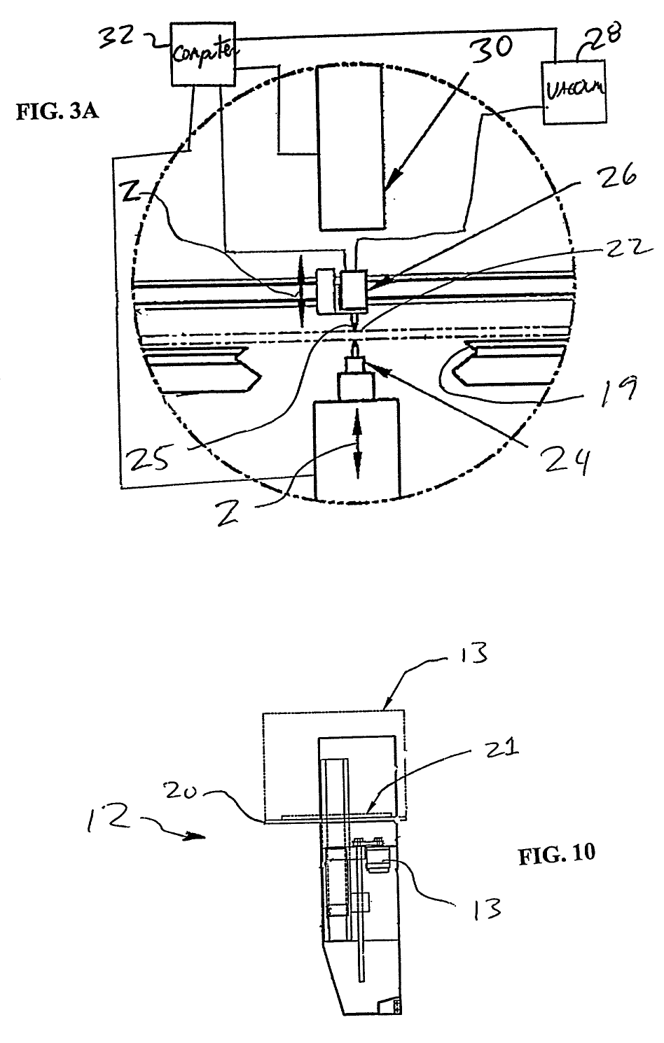

Turning now to FIGS. 1-3A, a detailed description concerning the basic components of the present invention will first be provided and this will be followed by a detailed description of the various components. As can be seen in these Figures, the automated feed mechanism 2 generally comprises an exterior support frame 4 which has a pair of opposed parallel sidewalls 6 and an pair of opposed end walls (not numbered). The pair of opposed sidewalls 6 which each comprise a main frame 8 and a base frame 10 (FIG. 3). The exterior surfaces of the pair of opposed sidewalls 6 define the width of the automated feed mechanism 2. The inwardly facing surfaces of the sidewalls 6 are preferably solid sidewalls which facilitate support of a plurality of spaced apart horizontally extending rails (not shown in detail) as well as various other components of the automated feed mechanism 2, which will be described below in further detail.

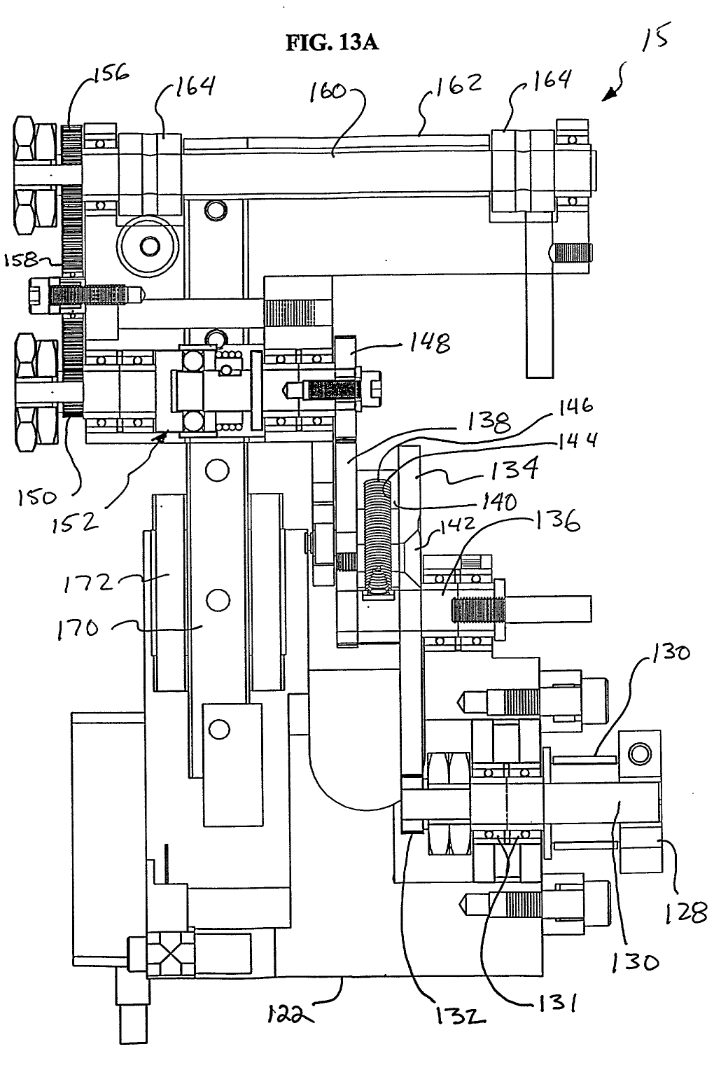

The support frame 4 generally supports four major components of the automated feed mechanism 2, namely, an elevator assembly 12, an input table/loader assembly 14, a pick and place assembly 16, and a shuttle assembly 18, and possibly an inverter assembly 15 (FIGS. 13-15D). The elevator assembly 12 stores an ample supply of wafer assemblies 20 (each wafer assembly 20 supporting a wafer 21 being formed of identical or similar electronic components 22) in a wafer assembly magazine 13 which has conventional shelves or slots (not shown in detail) for receiving a returned wafer assembly 20, e.g. a full or partially depleted wafer assembly 20 or a fully depleted wafer assembly 20 once all of the individual electronic components 22 are removed therefrom. The input table/loader assembly 14 facilitates retrieval of a desired wafer assembly 20 from wafer assembly magazine 13, supported by the elevator assembly 12, and conveyance of the retrieved wafer assembly 20 to the input table/loader assembly 14 where a desired amount of electronic components 22 can by sequentially retrieved and transported by the pick and place assembly 16 to shuttle assembly 18. The various electronic components 22 are initially stored, on the shuttle assembly 18, and then conveyed to a dispensing location D where the individual electronic components 22 can be retrieved, as necessary, and assembled by the automated assembly apparatus 3 into a desired end product.

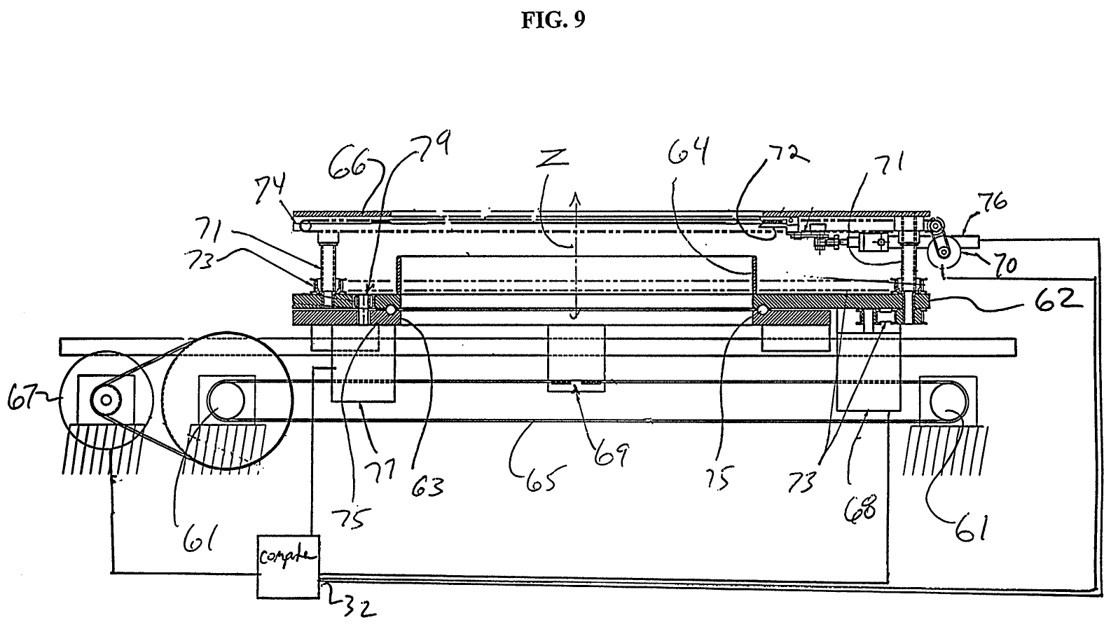

The components of the input table/loader assembly 14, which both facilitate retrieval of a desired wafer assembly 20 and return of the same back to the elevator assembly 12, generally reciprocate back and forth along a single elongate axis and move vertically, e.g. the components of the input table/loader assembly 14 only move back and forth along a Y-axis extending horizontally parallel to the sidewalls 6 of the support frame 4 and also move vertically along a Z-axis extending parallel to the sidewalls 6 of the support frame 4. The input table/loader assembly 14 is also provided with a mechanism to rotate an upper portion of the input table/loader assembly 14 to adjust the orientation of the wafer 21 and compensate for any misalignment of the wafer 21, supported by the wafer assembly 20, with respect to the support frame 4. Typically, this alignment feature allows for plus or minus seven degrees rotation of the wafer assembly 20 relative to the support frame 4. A further detailed description concerning such adjustment feature will follow below with reference to FIG. 9.

The pick and place assembly 16 generally comprises a pair of cooperating components, namely, a die elevation assembly 24 and a collet pick-up assembly 26, which work in unison with one another to facilitate sequential retrieval of each desired individual electronic component 22 from the wafer assembly 20. The die elevation assembly 24 has a conventional Z-axis actuation mechanism, e.g. one or more closely spaced pins or needles which are vertically movable along the Z-axis by actuation of a piston or in some other conventional or known manner, relative to a remainder of the die elevation assembly 24, to bias a rear surface of a desired one of the individual electronic components 22 away from the adherent film 19, supporting the electronic components, and possibly pierce through the adherent film 19.

The mating collet pick-up assembly 26 simultaneously moves downward along the Z-axis and engages with an opposed upwardly facing front surface of the slightly elevated individual electronic component 22 (FIG. 3A) and picks and completely removes that elevated individual electronic component 22 from the adherent film 19. The pick head 25, of the collet pick-up assembly 26, is coupled to a vacuum source 28 and the vacuum is actuated, once the pick head 25 is sufficiently lowered and engages with the desired electronic component 22, to facilitate retention and removal of that electronic component 22 from the adherent film 19 solely by the applied vacuum and the pins or needles.

Operation of the die elevation assembly 24, the collet pick-up assembly 26 and the orientation of the wafer assembly 20 are all observed by a machine vision camera 30. The machine vision camera 30 is coupled to a computer 32 to facilitate viewing of the wafer assembly 20, supported by the input table/loader assembly 14 as well as control operation of the die elevation assembly 24 and the collet pick-up assembly 26 via suitable control software incorporated in the computer 32. As such machine vision technology and control features are conventional and well known in the art, a further detailed description concerning the same is not provided.

The die elevation assembly 24 is able to move along two different axes, i.e. the die elevation assembly 24 can move back and forth along the X-axis extending horizontally perpendicular to the sidewalls 6 and can move up and down along the Z-axis extending vertically parallel to the sidewalls 6. The die elevation assembly 24 is conveyed to and fro along the X-axis, along a transverse crossbar 7, via an elongate lead screw (not shown in detail) which is driven by a die drive 23 electrically connected (not shown in detail) to the computer 32. A threaded nut is threadedly engaged with the lead screw and this nut is securely fastened to the die elevation assembly 24. Due to this arrangement, as the die drive 23 rotates the lead screw in a first rotational direction, such rotation of the lead screw causes the nut and the securely fastened die elevation assembly 24 to move in a first direction along the length of the lead screw and, as the die drive 23 rotates the lead screw in a second opposite rotational direction, such rotation of the lead screw causes the nut and the securely fastened die elevation assembly 24 to move in the opposite direction along the length of the lead screw.

The collet pick-up assembly 26, on the other hand, can move along three different axes, i.e. the collet pick-up assembly can move back and forth along the Y-axis extending horizontally parallel to the sidewalls 6, can move back and forth along the X-axis extending horizontally perpendicular to the sidewalls 6 and can move up and down along the Z-axis extending vertically parallel to the sidewalls 6.

The machine vision camera 30 can only move back and forth along the X-axis extending horizontally perpendicular to the sidewalls 6. The machine vision camera 30 is conveyed to and fro along the X-axis, along a transverse crossbar 9, via an elongate lead screw (not shown in detail) which is driven by a camera drive 30 electrically connected (not shown in detail) to the computer 32. A threaded nut is threadedly engaged with the lead screw and this nut is securely fastened to the machine vision camera 30. Due to this arrangement, as the camera drive 30 rotates the lead screw in a first rotational direction, such rotation of the lead screw causes the nut and the securely fastened machine vision camera 30 to move in a first direction along the length of the lead screw and, as the camera drive 30 rotates the lead screw in a second opposite rotational direction, such rotation of the lead screw causes the nut and the securely fastened machine vision camera 30 to move in the opposite direction along the length of the lead screw. A further detailed description concerning the operation and the function of the above two assembles and the camera will follow below.

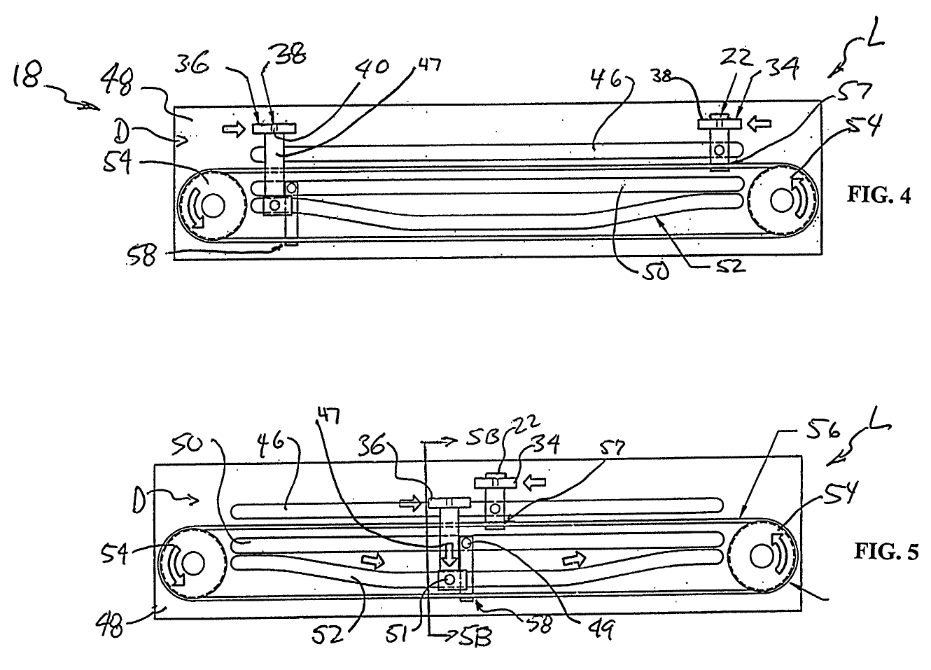

Once the desired electronic component 22 is retrieved by the collet pick-up assembly 26 and retained by a pickup head 25, via the applied vacuum from the vacuum source 28, the collet pick-up assembly 26 is then transported to a loading position L of the shuttle assembly 18 where the electronic component 22 is placed and temporarily stored on one of the first and the second shuttle platforms 34 or 36. Once the electronic component 22 is properly placed on a top surface 38 of the shuttle platform, e.g. on shuttle platform 34 (FIG. 4), the vacuum source 28 applied to the collet pick-up assembly 26 is discontinued, by the computer 32, to release the transported electronic component 22 so that the transported electronic component 22 is then supported solely by the top surface 38 of the shuttle platform 34 of the shuttle assembly 18. As noted above, the shuttle assembly 18 comprises first and second spaced apart shuttle platforms 34 and 36 onto which the transported electronic components 22 can be temporarily placed and stored for later retrieval by the automated assembly apparatus.

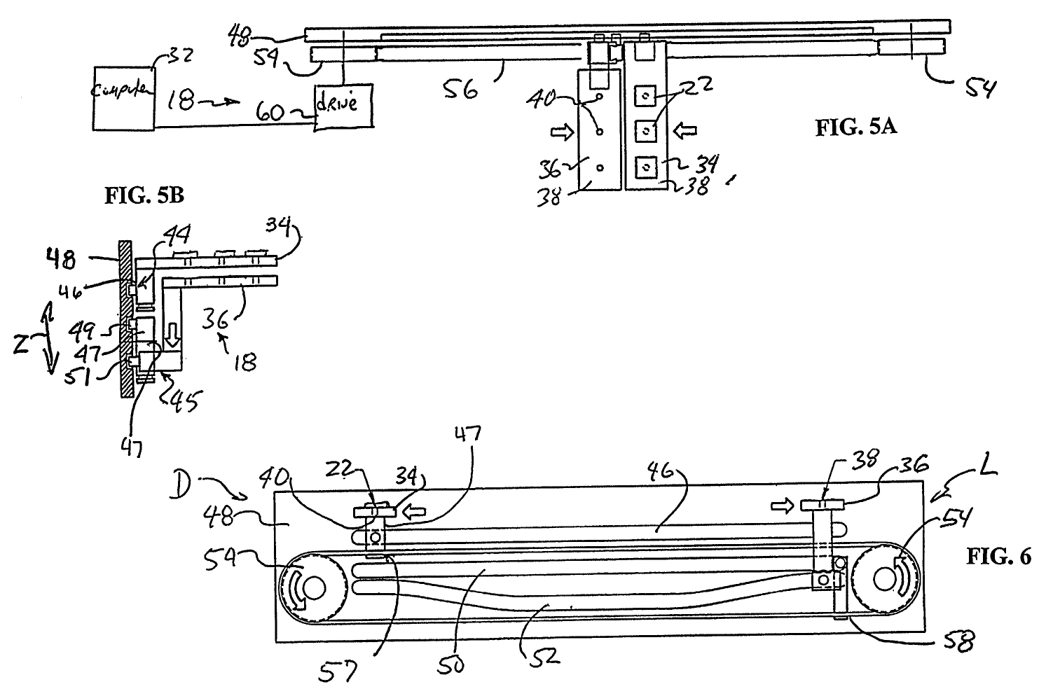

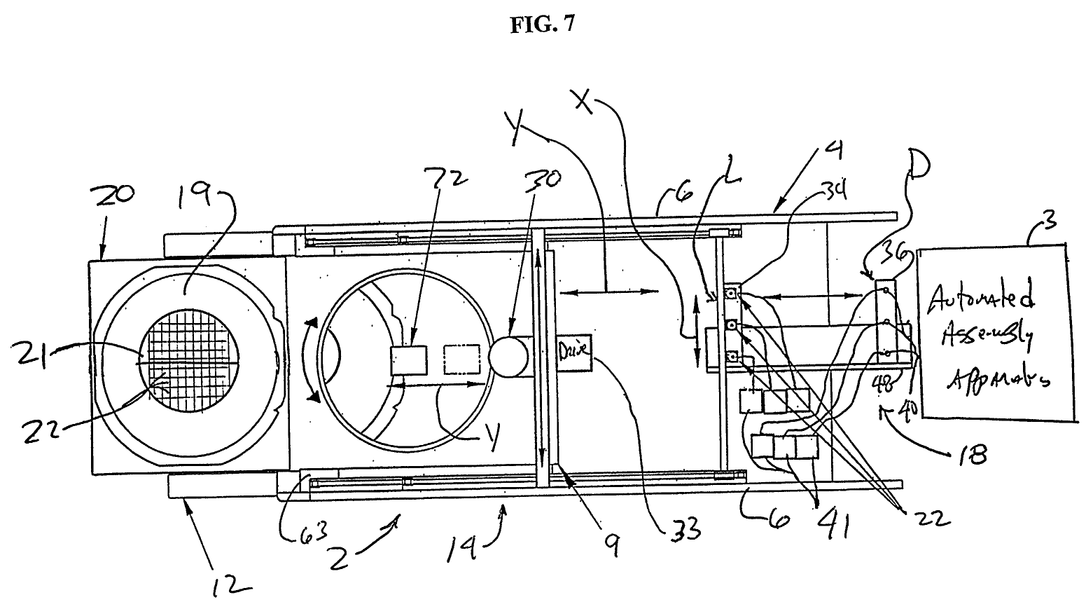

As can be seen in FIGS. 5A and 5B, each of the first and second shuttle platforms 34, 36 has at least one electronic component storage location 40 each capable of temporarily storing one electronic component 22 thereon for later retrieval by the automated assembly apparatus. It is to be appreciated that the number, the location and/or the spacing of the electronic component storage locations 40, along the top surface 38 of both of the first and the second shuttle platforms 34, 36, can vary from application to application and can be modified as necessary as would be apparent to one skilled in this art. Each one of the electronic component storage locations 40 is provided with at least one suction hole (not separately numbered), preferably a plurality of suction holes are formed in the top surface 38 of the first and the second shuttle platforms 34, 36 to facilitate support and retention of the placed and temporarily stored electronic component 22 thereon. In a preferred form of the invention, a separate suction source 41 (FIG. 7) is coupled to the suction hole(s) of each one of the electronic component storage locations 40, by flexible tubing (not labeled), and each separate suction source 41 is separately controlled by the computer 32. The computer 32 activates the vacuum for a desired one of the electronic component storage locations 40 once the vacuum source 28, applied to the collet pick-up assembly 26, is discontinued so as to securely retain and temporarily store the transported electronic component 22 on the top surface 38 of either the first or the second shuttle platform 34 or 36 for later retrieval of the electronic component 22, by the automated assembly apparatus 3, once the shuttle platform 34 or 36 is later transported and located at the dispensing location D.

When assembly of one of the transported electronic components 22, currently located at the dispensing position D, is desired by the automated assembly apparatus 3, the automated assembly apparatus 3 is programmed, in a conventional manner, to retrieve that desired electronic component 22 at substantially the same time that the computer 32 discontinues the supply of vacuum to the corresponding electronic component storage location 40 so that the temporarily stored electronic component 22 can be readily retrieved by the automated assembly apparatus 3 for production purposes. To facilitate operation of the shuttle assembly 18, it is imperative that the top surfaces 38 and the electronic components storage locations 40 of both the first and second shuttle platforms 34, 36 occupy substantially identical positions, whether in the loading position L or in the dispensing position D, so that the automated feed mechanism 2 and the automated assembly apparatus 3 are not effected by which one of the two shuttle platforms 34 or 36 is receiving or dispensing electronic components 22.

As both the first and the second shuttle platforms 34, 36 are quite similar to one another, first a detailed description with respect to the first shuttle platform 34 will be provided and this will be followed by a detailed description concerning the differences incorporated in the second shuttle platform 36.

The first shuttle platform 34 is generally L-shaped (FIG. 5B) and is provided with a conventional first guide and bearing mechanism 44 supported along a side surface of the shorter leg (not labeled). The first guide and bearing mechanism 44 allows the first shuttle platform 34 to be conveyed vertically back and forth, in a reciprocating fashion, along a first elongate linear track 46 formed in a guide rail 48 of the shuttle assembly 18 and extending along the Y-axis. The first shuttle platform 34 is securely fastened to the guide and bearing mechanism 44 and moves to and fro along the Y-axis along with the first guide and bearing mechanism 44. As can be seen in FIGS. 1 and 7, the first shuttle platform 34 extends perpendicular to the sidewalls 6 of the support frame 4 and is conveyed in a direction parallel to the sidewalls 6, i.e. conveyed along the Y-axis.

The second shuttle platform 36 is mounted in a somewhat different manner, but extends and moves in substantially the same direction as the first shuttle platform 34, i.e. the second shuttle platform 36 also extends perpendicular to the sidewalls 6 and is conveyed in a direction parallel to the sidewalls 6. However, the second shuttle platform 36, when moving from a dispensing position D, located remote from the input table/loader assembly 14 and adjacent a retrieval station of the automated assembly apparatus 3 (the left side position as seen in FIGS. 4-6), to a loading position L, located adjacent the input table/loader assembly 14 (the right side position as seen in FIGS. 4-6), also reciprocates vertically up and down along the Z-axis, extending normal to a floor surface, to facilitate a gentle and gradual lowering of the second shuttle platform 36 relative to the first shuttle platform 34 (FIGS. 4, 5 and 5B) and passage of the first and the second shuttle platforms 34, 36 by one another as they each move to the other of the loading and the dispensing positions L or D without abutting or interfering with one another or any carried electronic components 22.

As the second shuttle platform 36 approaches either the loading or the dispensing position L or D, the second shuttle platform 36 gradually rises to exactly the same vertical level or height so as to occupy substantially the same position occupied by the first shuttle platform 34 when in that same position. That is, the position of the top surface 38 of the first shuttle platform 34, when in the loading position L, is identical to the position of the top surface 38 occupied by the second shuttle platform 36 when in the loading position L, and the position of the top surface 38 of the first shuttle platform 34, when in the dispensing position D, is substantially identical to the position of the top surface 38 occupied by the second shuttle platform 36 when in the dispensing position D. This feature facilitates uniform placement of the electronic components 22 on either the first or the second support platform 34 or 36, when located at the loading position L, as well as uniform retrieval of the electronic components 22, from either the first or the second shuttle platforms 34 or 36, when located at the dispensing position D.

To facilitate the gentle lowering of the second shuttle platform 36 along the Z-axis, a pair of second guide tracks 50, 52 are formed in the guide rail 48 of the shuttle assembly 18 beneath the first elongate linear track 46 (FIGS. 4-6). A top one of the pair of guide tracks 50 is a substantially linear track, extending along the Y-axis, while a second lower one of the pair of guide tracks 52 is a somewhat curved or radius track to facilitate a gradual lowering of the second shuttle platform 36 as the second shuttle platform 36 is conveyed from one of the loading or dispensing position L or D to the other of the loading or dispensing position L or D.

The second shuttle platform 36 is L-shaped and provided with a second guide and bearing mechanism 45, on a shorter leg side surface thereof, which allows the second shuttle platform 36 to be conveyed back and forth, in a reciprocating fashion along the linear guide track 50 formed in a guide rail 48 of the shuttle assembly 18 and also facilitates up and down reciprocating movement of the second shuttle platform 36 along the Z-axis. To facilitate such movement, the guide and bearing mechanism 45 includes a housing 47 having a first guide 49 engaging with the first top one of the pair of guide tracks 50 and also includes a second guide 51 which is directly secured to a downwardly extending shorter leg of the second shuttle platform 36. The housing 47 captively retains the second guide 51 while still allowing the second shuttle platform 36 to move along the Z-axis relative to the housing 47 and the first guide 49. As the second shuttle platform 36 is conveyed from one of the loading and dispensing positions L or D to the other of the loading and dispensing positions L or D, the curvature of the second guide track 52 gently lowers the second shuttle platform 36 by a sufficient distance (FIGS. 5-5B), e.g. a distance of about 0.25 inch to about 0.56 inch or so, to provide suitable clearance between the first and the second shuttle platforms 34, 36 as they pass by one another.

The same side surface of the guide rail 48, which supports the guide tracks 46, 50, 52, also supports a pair of spaced apart end rollers 54, one located adjacent the loading position L and the other located adjacent the dispensing position D of the shuttle assembly 18 and an endless belt 56 is wrapped around the pair of spaced apart rollers 54. A lower portion of the first shuttle platform 34 is coupled or clamped at 57, in a conventional manner, to a first upper section of the endless belt 56 when the first shuttle platform 34 is in one of the loading and dispensing positions L or D, while a lower portion of the second shuttle platform 36 is coupled or clamped at 58, in a conventional manner, to an opposed lower section of the endless belt 56 when the second shuttle platform 36 is in the other of the loading and dispensing positions L or D. By this arrangement, as the endless belt 56 is driven by a shuttle motor or drive 60 (FIG. 5A) in a first direction, e.g. counterclockwise as seen in FIG. 4, the first and the second shuttle platforms 34, 36 initially move toward one another and, once the second shuttle platform 36 is lowered and passes underneath the first shuttle platform 34 (FIGS. 5 and 5B), the two shuttle platforms then continue to move away from one another until they reach their other end position (FIG. 6) where the electronic components 22 can be removed from the first shuttle platform 34.

If the endless belt 56 is now driven in a reverse direction by shuttle motor or drive 60, e.g. rotated clockwise, the two shuttle platforms 34, 36 again initially move toward one another and once the second shuttle platform 36 again passes underneath the first shuttle platform 34 (FIGS. 5-5B), then the two shuttle platforms 34, 36 again continue to move away from one another until they reach their previous end positions (FIG. 4). Such conveying motion of the first and the second shuttle platforms 34, 36, of the shuttle assembly 18, facilitates transfer of one of the first and second shuttle platforms 34 or 36, which was just loaded with electronic components 22 by the automated feed mechanism 2, from the loading position L to the dispensing position D, adjacent the automated assembly apparatus 3, so that those loaded individual electronic components 22 can be retrieved and assembled into a desired product by the automated assembly apparatus. Simultaneously therewith, the other of the first and second shuttle platforms 36 or 34, which was just depleted of electronic components 22 by the automated assembly apparatus 3, is transferred to the loading position L, adjacent the automated feed mechanism 2, so that additional electronic components 22 can be loaded thereon by the pick and place assembly 16.

Once all of the electronic components 22 are retrieved from the shuttle platform 34 or 36 located at the dispensing position D, adjacent the automated assembly apparatus, and once additional electronic components 22 are loaded on the shuttle platform 36 or 34 located at the loading position L, adjacent the automated feed mechanism 3, the shuttle motor or drive 60 is reversed so that the shuttle platform 34 or 36, at the loading position L is reconveyed back to the dispensing position D while the shuttle platform 36 or 34 at the dispensing position D is simultaneously reconveyed back to the loading position L. This operation is repeated through the production cycle of the automated feed mechanism 2.

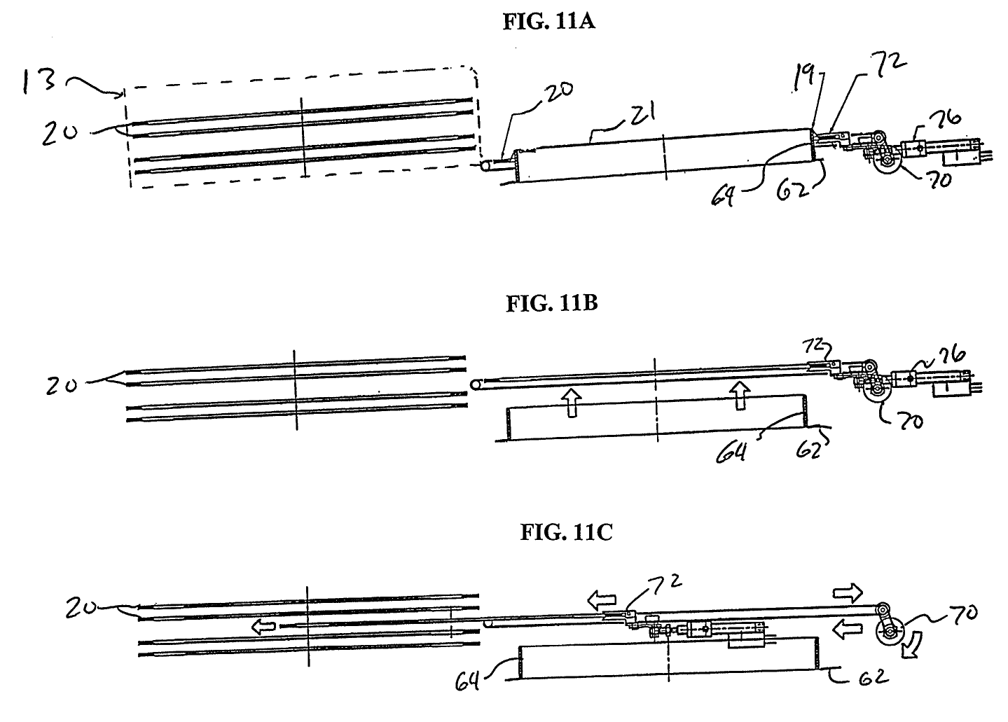

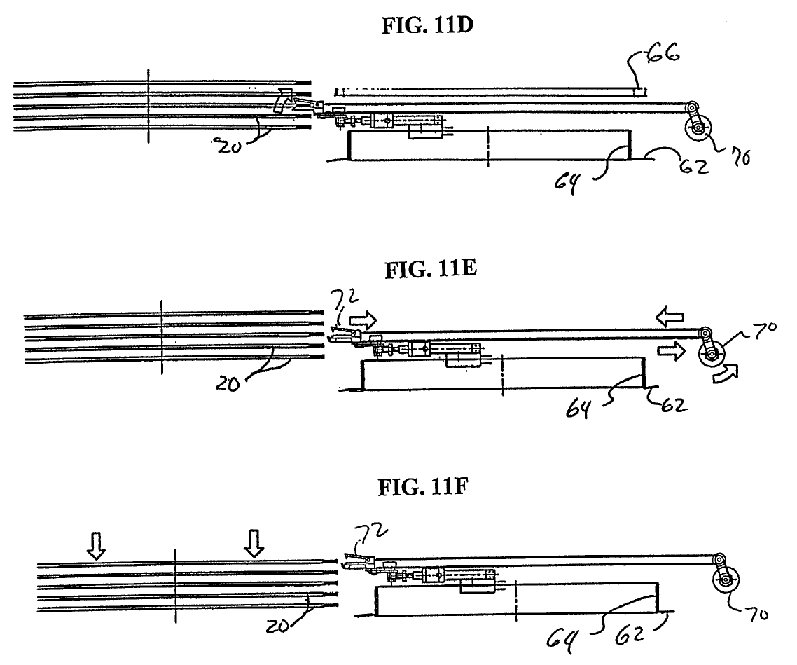

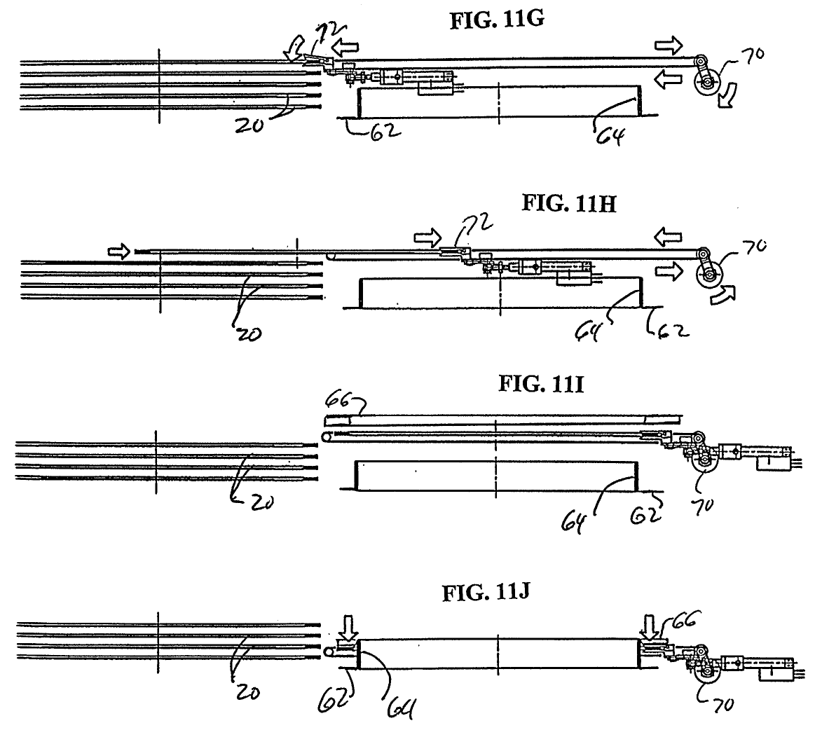

With reference now to FIGS. 7-11J, a detailed description concerning the input table/loader assembly 14 and its cooperation with the elevator assembly 12 will now be provided. As can be seen in further detail in FIGS. 10 and 11A, a plurality of wafer assemblies 20 are located at different vertical height on shelves in the wafer assembly magazine 13 supported on the elevator assembly 12. The elevator assembly 12 is located in close proximity to, but spaced from a feed end of the input table/loader assembly 14 to facilitate transfer of a desired wafer assembly 20 between these two assemblies.

The input table/loader assembly 14 generally comprises a lower table 62 (FIG. 9) with a central circular opening supporting a cylindrical ring 64 thereon. The cylindrical ring 64 has a diameter larger than the diameter of the wafer 21 but smaller than the diameter of the film frame of the wafer assembly 20, so that the film frame can be lowered around the outer circumference of the cylindrical ring 64, via an upper table 66, to stretch the adherent film 19 and partially separate the various electrical components 22, comprising the wafer 21, and facilitate separation and removal from the adherent film 19 as well as any adjacent electronic components 22. As such, stretching feature is conventional and well known in the art, a further detailed description concerning the same is not provided.

Both the lower table 62 and the upper table 66 are supported on a movable table platform 63 (FIG. 9). The movable table platform 63 is conveyable to and fro along the Y-axis extending horizontally parallel to the sidewalls 6 to a location adjacent the elevator assembly 12 as well as to a location remote from the elevator assembly 12 and adjacent the pick and place assembly 16. The movable table platform 63 must be movable along the Y-axis by a distance greater than the diameter of the wafer 21 being supported by the wafer assembly 20. The movable table platform 63 is movable along a pair of opposed table rails (not numbered) supported by the inwardly facing surface of the sidewalls 6. A pair of spaced apart rollers 61 are supported by one of the sidewalls 6, adjacent one of the table platform rails, and an endless belt 65 extends around this pair of table rollers 61. A table motor 67 is coupled, in a conventional manner, to drive one of the pair of spaced apart rollers 61 and, in turn, the endless belt 65. A bottom surface of the movable table platform 63 is clamped, at 69, to the endless belt 65. As the table motor 67 conveys the endless belt 65 in a first direction, the movable table platform 63 is conveyed along the Y-axis in a first direction toward the end position located adjacent the elevator assembly 12. If the direction of the table motor 67 is reversed, the movable table platform 63 is conveyed in an opposite direction to a position remote from the elevator assembly 12.

In addition, the lower table 62 and the upper table 66 are both movable relative to the movable table platform 63. In particular, the upper and lower tables 62, 66 can move relative to the movable table platform 63 over an angle of approximately plus or minus seven degrees. To facilitate this, the lower table 62 is supported on the movable table platform 63 by a plurality of circumferential bearings 75. The bearings 75 are located adjacent, but spaced radially outwardly of the cylindrical ring 64. A theta axis drive motor 77 is secured to a bottom surface of the movable table platform 63. An aperture is provided in the movable table platform 63 and a gearing 79 of the theta drive motor 77 extends therethrough and is coupled to a mating gearing provided on the lower table 62. Due to this arrangement, as the theta drive motor 77 is rotated in one direction, both the upper and lower table 62, 66, as well as any supported wafer assembly 20, are rotated relative to the movable table platform 63. Accordingly, in the event that the orientation of a wafer 21, supported on a retrieved wafer assembly 20 and sandwiched between the upper and lower tables 62, 66, is determine by the machine vision camera 30, in a conventional fashion, to be misaligned or skewed, for some reason, the computer 32 sends a signal to the theta drive motor 77 to rotate the upper and lower table 62, 66, relative to the movable table platform 63, a desired angle to compensate for such minor misalignment of the supported wafer 21. As the detection of such skew or misalignment feature of the wafer 21 is conventional and well known in the art, a further detailed description concerning the same is not provided.

As can be seen in FIG. 1 1A, a wafer assembly 20 is shown in a stretched position in engagement with the cylindrical ring 64. Once all of the desired electronic components 22 from the wafer 21 have been retrieved and/or electronic components 22 from a different wafer assembly 20 are required by the automated assembly apparatus 3, the computer 32 actuates upper table drive 68 to raise the upper table 66 vertically along the Z-axis relative to the cylindrical ring 64 (FIGS. 9 and 11 B). To achieve this, the upper table drive 68 is coupled to four screw assemblies 71 coupling the lower table 62 to the upper table 66, via a plurality of belts 73, to cause simultaneous rotation of the four screw assemblies 71 and relative movement between the lower and upper tables 62, 66 along the Z-axis. Such motion causes the tension applied to the adherent film 19 of the wafer assembly 20 to be gradually relieved so that the wafer assembly 20 eventually again assumes its initial slightly sagging configuration. The upper table 66 continues moving relative to the cylindrical ring 64 until the wafer assembly 20 is elevated a sufficient distance away from a top surface of the cylindrical ring 64 to allow uninhibited movement of the wafer assembly 20 along the Y-axis (FIG. 11 B). Once the four screw assemblies 71 reach their fully rotated end positions, a signal is sent to the computer 32 indicating that the upper table 66 is sufficiently raised and spaced from the lower table 63, e.g. is spaced by a distance of between 0.25 inch and 1.0 inch or so.

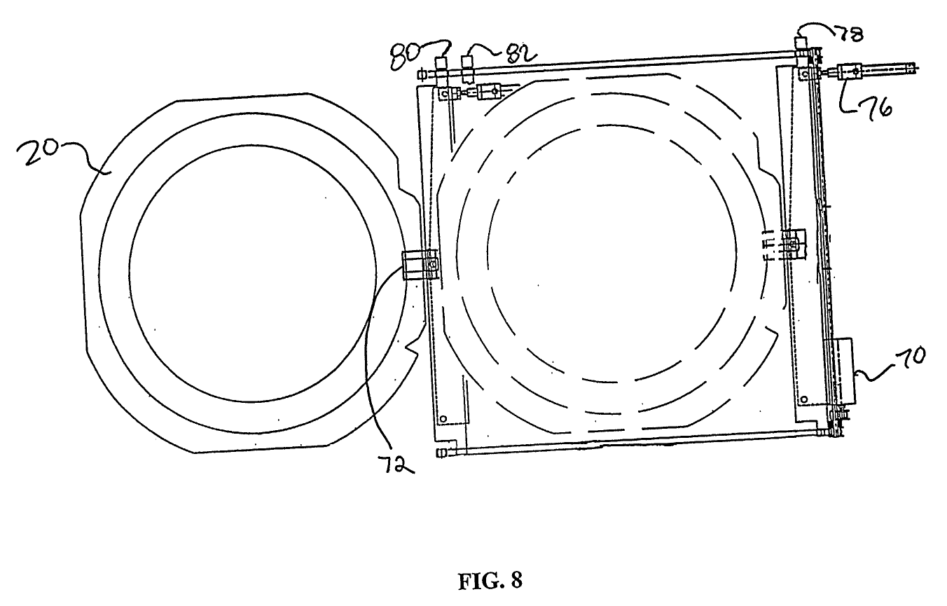

The table motor 67 is actuated to convey the movable platform table 63 to a location adjacent the elevator assembly 12. Next, a loader advance retraction motor 70 is actuated which causes the loader catch 72, clamped to a periphery of the wafer assembly 20, to be conveyed along the Y-axis from a position remote from the elevator assembly 12 and clear of the cylindrical ring 64 (FIG. 11 B), along a pair of opposed rails 74 located along a downwardly facing surface of the upper table 66, to a position adjacent the wafer assembly magazine 13 of the elevator assembly 12 and facilitate the return of the emptied wafer assembly 20 along a desired pair of supports or shelf of the wafer assembly magazine 13. The return position of the loader catch 72 is shown in FIG. 11D while an intermediate return position is shown in FIGS. 8 and 11 C. The loader advance/retraction motor 70 continues to operate until the wafer assembly 20 is sufficiently received and accommodated by a desired shelf or slot of the wafer assembly magazine 13 (FIG. 11D).

Once this occurs, the return motion of the loader catch 72 is discontinued and a catch actuating cylinder 76 is de-energized by the computer 32 to release the wafer assembly 20 from the loader catch 72. The loader catch 72 comprises a pair of mating jaws which are pivotally connected to one another to move from an open position (FIG. 11 E, for example) to a closed position (FIG. 11G) to facilitate both grasping of and release of a desired wafer assembly 20. The loader advance/retraction motor 70 is then reversed and partially retracted to completely separate the loader catch 72 from the returned wafer assembly 20. The partially retracted position of the loader catch 72 is shown in FIG. 11E.

The computer 32 then either raises or lowers the wafer assembly magazine 13 by an elevator drive 11 coupled to the elevator assembly 12, along the Z-axis a sufficient distance in a conventional manner, so that desired wafer assembly 20, containing additional components 22 to be assembled, is suitably aligned with the load catcher 72 and can be retrieved from the shelf or slot of the wafer assembly magazine 13. As shown in FIG. 11F, the elevator assembly 12 is lowered so that the topmost wafer assembly 20 can be retrieved. Once the wafer assembly magazine 13 is sufficiently raised or lowered by the elevator drive 11, the loader advance/retraction motor 70 is again moved toward the elevator assembly 12 so that the loader catch 72 can engage with and retrieve a desired wafer assembly 20 from the wafer assembly magazine 13. Once the loader catch 72 is appropriately positioned, the catch actuating cylinder 76 is energized to actuated the loader catch 72 and clamp a periphery of the desired wafer assembly 20, as can be seen in FIG. 11 G. The loader advance/retraction motor 70 is then reversed so that the loader catch 72 is reconveyed back, along with the engaged wafer assembly 20, along the pair of rails 74 back toward the loader catch's initially retracted position, shown in FIG. 11_{I}.

Once the loader advance/retraction motor 70 reaches its final retracted end position, which is sensed by the computer 32, the retrieved wafer assembly 20 is substantially centered with respect to the cylindrical ring 64. The upper table 66 is again lowered, with respect to the lower table 62, back toward its initial position shown in FIG. 11A. Such lowering motion causes the top circumferential surface of the cylindrical ring 64 to engage with a downwardly facing undersurface of the adherent film 19. Further lowering motion of the upper table 66, with respect to the lower table 62 and the cylindrical ring 64, causes the adherent film 19 to stretch, much like a covering for a conventional drum is stretched, to facilitate a suitable separation of each of the individual electronic components 22, comprising the wafer 21, from any adjacent electronic component 22 and facilitate retrieval of the individual electronic components 22 when required. The final end position of the retrieved wafer assembly 20 is shown in FIG. 11J. Thereafter, the pick and place assembly 16 can be operated to convey the electronic components 22 to the shuttle assembly 18 as described above.

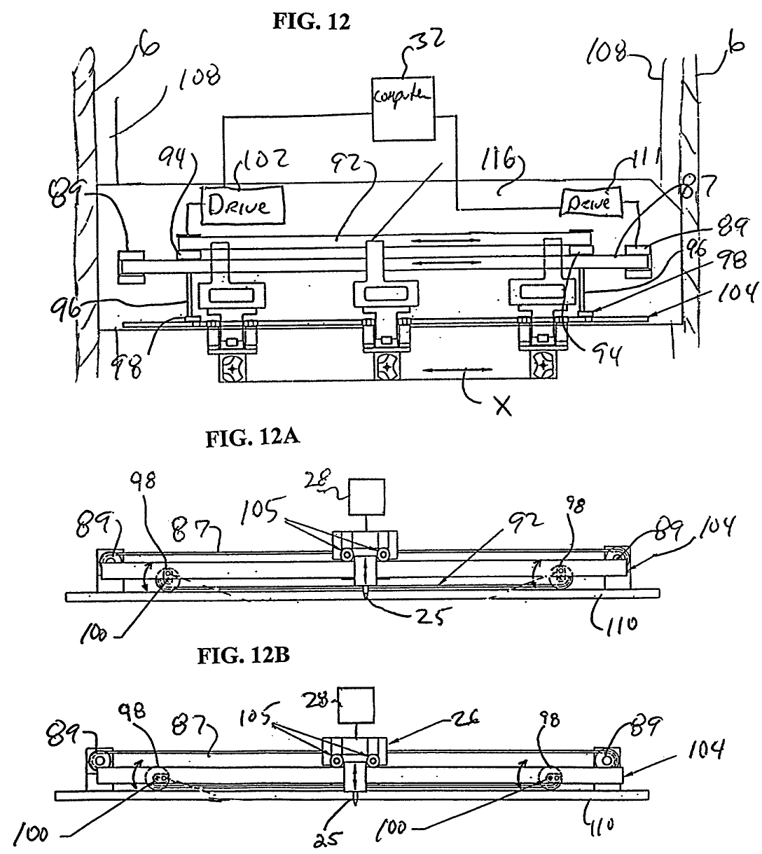

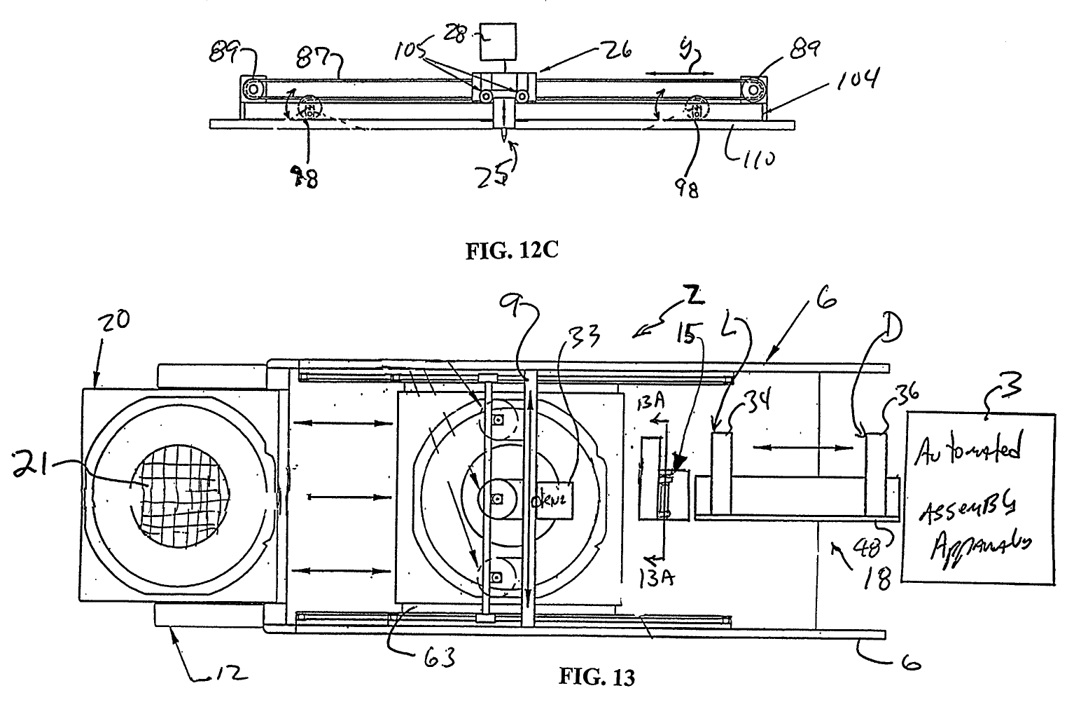

The input table/loader assembly 14 is provided with a first sensor 78 (FIG. 8) to sense the completely retracted position of the loader catch 72. A signal generated by the first sensor 78 is sent to the computer 32 to facilitate control of a loader catch motor 70 coupled to the loader catch 72. A second sensor 80 is provided to determine when the loader catch 72 engages with a new wafer assembly 20 to be retrieved. The second sensor 80 also sends a signal to the computer 32 to facilitate operation of the loader catch 72. A third sensor 82 is provided to sense when the loader catch 72 is clear of the wafer assembly 20 so that the elevator assembly 12 can be actuated to be either raised or lowered, as necessary, to facilitate retrieval of a new wafer assembly 20 therefrom. A fourth sensor (not shown in detail) can be provided to monitor the state of the jaws of the loader catch 72 With reference to FIGS. 3, 3A and 12-12C, a further discussion relating to the operation of the collet pick-up assembly 26 will now be provided. As can be seen in FIG. 3, the collet pick-up assembly 26 is conveyed to and fro along the Y-axis by an endless belt 86 which is wrapped around two spaced apart rollers 88. A Y-axis collet drive 110 rotates the endless belt 86 in either a first rotational direction or a second rotational direction, to convey the collet pick-up assembly 26 to and fro along the Y-axis extending horizontally parallel to the sidewalls 6. The collet pick-up assembly 26 is also conveyed to and fro along the X-axis (FIGS. 12-12C) by a second endless belt 87 which is wrapped around two spaced apart rollers 89. A X-axis collet drive 111 rotates the endless belt 87 in either a first rotational direction or a second rotational direction, to convey the collet pick-up assembly 26 to and fro along the X-axis extending horizontally perpendicular to the sidewalls 6. To facilitate movement of the collet pick-up assembly along the Z-axis, a third endless belt 92 is provided which rotates about a pair of spaced apart rollers 94. The two spaced apart rollers 94 both are coupled, via a respective shaft 96, to an eccentric cam 98 and each eccentric cam 98 is capable of being rotated 180° about a central pivot point 100. A peripheral portion of eccentric cam 88 is coupled to a transverse crossbar 104 to facilitate up and down movement of the transverse crossbar 104 along the Z-axis. The collet pick-up assembly 26 is directly supported by the transverse crossbar 104 and has a pair of rollers 105 to facilitate rolling movement of the collet pick-up assembly 26 along a top surface of the crossbar 104. A Z-axis collet drive 102 is coupled to control limited rotation of one of the two spaced apart rollers 94.

The eccentric cams 98 and transverse crossbar 104, when in a first rotated position (see FIG. 12A), maintain the collet pick-up assembly 26 in a totally elevated or retracted position which is clear of the wafer assembly 20 and the vacuum source 28 is generally not operating when the collet pick-up assembly 26 is in this position. When automated feed mechanism 2 desires to retrieve an individual electronic component 22, via the collet pick-up assembly 26, the Z-axis drive 102 is operated which rotates both of the eccentric cams 98 in a clockwise (or possibly a counterclockwise) direction, as seen in FIGS. 12A-12C. Such rotation, in turn, causes the eccentric cams 98 to pivot, relative to their central pivot points 100, to a lower most position (FIG. 12C). Such pivoting motion, in turn, lowers a transverse crossbar 104 along with the collet pick-up assembly 26. The lowering of the transverse crossbar 104 positions the picking head 25 (FIG. 3A) of the collet pick-up assembly 26 adjacent a top surface of a desired individual electronic component 22 to be retrieved from the wafer assembly 20. Once the picking head 25 of the collet pick-up assembly 26 contacts the desired electronic component 22, the vacuum source 28 is activated so that the collet pick-up assembly 26, in unison with the pushing motion of the die elevation assembly 24, can remove the desired electronic component 22 from the wafer assembly 20 and facilitate conveyance of the same to the shuttle assembly 18, as described above.

The collet pick-up assembly 26 includes a pair of opposed parallel rails 108 which are each supported by one of the sidewalls 6 of the automated feed mechanism 2. A traverse arm 116 extends between the rails 108 and supports the collet pick-up assembly 26. The Y-axis collet drive 110 conveys the transverse arm 116 along the sidewalls 6 to provide the Y-axis movement of the collet pick-up assembly 26.

The die elevation assembly 24 is supported along a transverse crossbar 7 located beneath the movable table platform 63 (FIG. 3). As noted above, the die drive 23 is coupled to a lead screw to control movement of the die elevation assembly 24 along the X-axis extending horizontally perpendicular to the sidewall 6. The plurality of pins or needles, e.g. typically between one and five spaced apart pins or needles, provided on a movable portion of the die elevation assembly 24 facilitate engagement of a leading portion of those plurality of pins or needles with a rear surface of the electronic component 22 to be retrieved by the collet pick-up assembly 26.

It is to be appreciated that the die extraction assembly 24 and the machine vision camera 30 do not have any movement along the Y-axis of the automatic feed mechanism 2. That is, the movable table platform 63 is moved relative to the die extraction assembly 24 and the machine vision camera 30 to provide relative Y-axis movement of the wafer assembly 20 with respect to those two components. In addition, the collet pick-up assembly 26 and the die elevation assembly 24 are both controlled by the computer 32 to operate in unison with one another and facilitate retrieval in a desired electronic component 22 from the wafer assembly 20.

During typical operation, the input table/loader assembly 14 is in constant communication with the elevator assembly 12 to return and retrieve the various wafer assemblies 20 required by the automated assembly apparatus 3. As the automated assembly apparatus 3 is manufacturing a product, the automated assembly apparatus 3 may require electronic components 22 to be retrieved from one to as many as twenty five different wafer assemblies 20. The computer 32 is provided with the necessary information so that the computer 32 controls operation of the automatic feed mechanism 2 to retrieve the desired wafer assembly 20 from the elevator assembly 12 and locate the same for retrieval by the pick and place assembly 16. The pick and place assembly 16 then transports a desired quantity of the electronic components 22, supported on that wafer assembly 20, to the shuttle assembly 18 for use by the automated assembly apparatus 3. Thereafter, the input table/loader assembly 14 then returns that wafer assembly 20 back to the wafer assembly magazine 13 and retrieves any additional wafer assembly(s) 20 required to complete production of the product. The automatic feed mechanism 2, according to the present invention, speeds up the production time and minimizes the idle or standby time of the automatic assembly apparatus 3 to improve the overall production time of various end products.

According to the present invention, at least the die elevation assembly 24, the collet pick-up assembly 26 and the machine vision camera 30 all employ “electronic gearing” control technology. Such gearing technology provides a more precise movement of each of these components along the X-, Y- and/or Z-axes which is critical for pick and placement of electronic parts. During normal operation, the die elevation assembly 24 and the machine vision camera 30 are both simultaneously incrementally moved along their translationally X-axis to a precise location to pick-up a further electronic component while avoiding contact or collision with the collet pick-up assembly 26 when moving to and fro along the Y- or Z-axes. To facilitate movement of the machine vision camera 30 and the die elevation assembly 24, relative to the wafer 21, the table drive 67 is actuated to convey the movable platform table 63 to and fro along the Y-axis to provide the Y-axis movement of the wafer relative to the die elevation assembly 24 and the machine vision camera 30. The electronic gearing control technology is typically computer software which is incorporated into the computer 32 and utilized by the computer 32 to control operation of the various drives and precisely position, at least, the die elevation assembly 24, the collet pick-up assembly 26 and the machine vision camera 30 at desired locations.

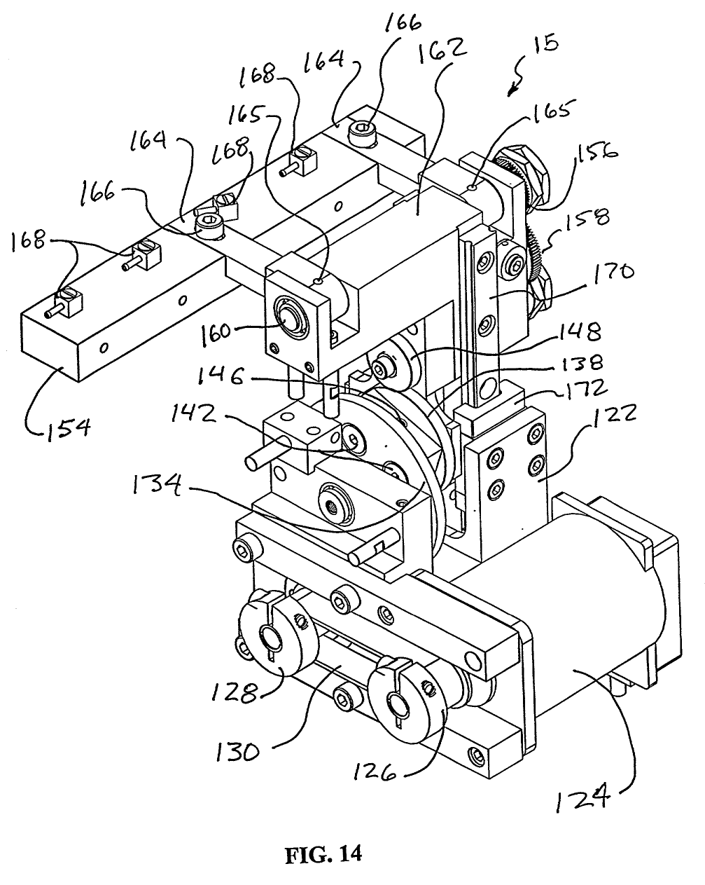

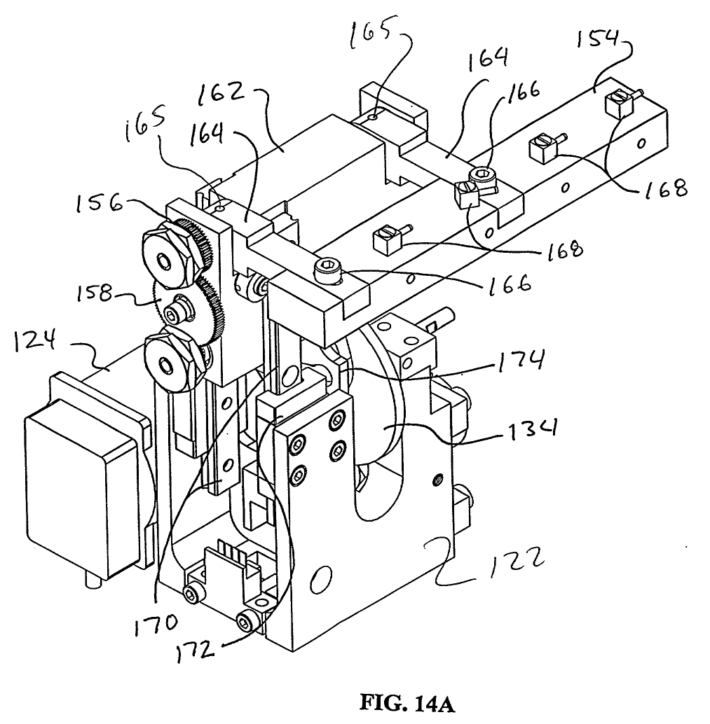

With reference now to FIGS. 13, 13A, 14 and 14A, a detailed description concerning a second embodiment of the present invention will now be provided. The major difference between this embodiment, and the previous embodiment, is the addition of an inverter assembly 15 at a location between the pick and place assembly 16 and the first and second shuttle platforms 34, 36 of the shuttle assembly 18. The purpose of the inverter assembly 15 is to receive one or more electronic components 22, retrieved by the pick and place assembly 16, and facilitates flipping or inverting of the electronic components 22, as the electronic components 22 are transferred from the inverter assembly 15 and placed on either the first or the second shuttle platforms 34, 36, so that the electronic components 22 will thereafter be retrieved by the automated assembly equipment in the flipped or inverted manner.

As can seen in FIGS. 13, 13A, 14 and 14A, the inverter assembly 15 generally comprises an inverter housing 122, connected to the support frame 4 (not shown in detail), accommodating an inverter motor 124 for supplying rotational drive to the inverter assembly 15. The inverter motor 124 is electrically connected to (not shown) and controlled by the computer 32. A drive output of the inverter motor 124 supports a first belt gear 126 (FIG. 14) which is coupled to a second belt gear 128 via a conventional flexible drive transfer belt 130. The second belt gear 128 is coupled, via a belt transfer shaft 130, to a first toothed gear 132 (FIG. 13A). The transfer shaft 130 extends through a wall of the inverter housing 122 and a pair of bearings 131 facilitate rotation of the transfer shaft 130 relative to the inverter housing 122.

The first toothed gear 132 matingly engages with a second toothed gear 134 to supply rotational drive from the inverter motor 124 to the second toothed gear 134. A second toothed gear shaft 136 engages with a center portion of the second toothed gear 134 to facilitate rotation of the second toothed gear 134, about a pivotal axis of rotation, with respect to the inverter housing 122. A third toothed gear 138 and gear spacer 140 are both eccentrically supported by a rear side surface of the second toothed gear 134. The gear spacer 140 spaces the third toothed gear 138 from the rear side surface of the second toothed gear 134 by a distance of about ¼ to ½ of an inch or so. Preferably two hex screws 142 facilitate non-rotational attachment of the third toothed gear 138 and the gear spacer 140 to the rear side surface of the second toothed gear 134. An aperture 144 is formed in the gear spacer 140 to facilitate attachment of the third toothed gear 138, the gear spacer 140 and the second toothed gear 134 to the second tooth gear shaft 136 at a desired axial position along the length of the second tooth gear shaft 136. A set screw 146 is received within the aperture 144 of the gear spacer 140 and fastens the third toothed gear 138, the gear spacer 140 and the second toothed gear 134 at the desired axial position along the second toothed gear shaft 136.

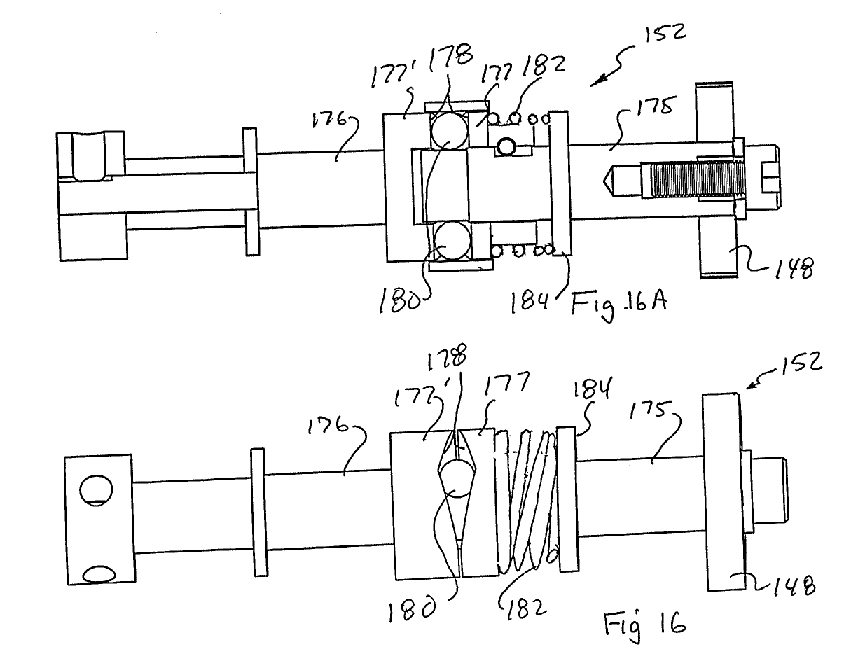

The third toothed gear 138 matingly engages with a fourth toothed gear 148 to supply rotational drive thereto. The fourth toothed gear 148 is, in turn, coupled to first inverter gear 150, via a clutch member 152 (see FIGS. 16 and 16A), to supply rotation drive from the inverter motor 124 thereto. The clutch member 152 allows a limited amount of rotation between the fourth toothed gear 148 and the first inverter gear 150 once the inverter platform 154 has pivoted or rotated a full 180 degrees relative to an invert shuttle 162. A further detailed description concerning the purpose and function of the clutch member 152 will be provided below.

The first inverter gear 150 is, in turn, coupled to a second inverter gear 156, via an intermediate pinion gear 158. The second inverter gear 156 is securely fastened to an inverter shaft 160 so that as the second inverter gear 156 is driven by the inverter motor 124 and rotates relative to the inverter shuttle 162, the inverter shaft 160 rotates an identical amount to the amount of rotation of the second inverter gear 156. A pair of radially extending inverter arms 164 are each securely fastened to the inverter shaft 160, at locations spaced from one another, so that the inverter arms 164 rotate along with the inverter shaft 160. A pair of set screws 165, one for each one of the inverter arms 164, are received within a respective hole of the inverter arms 164 to facilitate fastening of the inverter arms 164 to the inverter shaft 160 in a conventional manner.

A remote free end of each of the inverter arms 164 is fastened to a undersurface of the inverter platform 154 via at least one bolt 166 or screw or some other a conventional fastening mechanism. The undersurface of the inverter platform has a plurality of spaced apart vacuum couplings 168 and each vacuum coupling 168 communicates with at least one, and preferably a plurality of respective apertures (not shown) formed in a top surface of the inverter platform 154 to supply a vacuum to top surface of the inverter platform 154 to facilitate retention of an electronic component 22 when placed thereon.

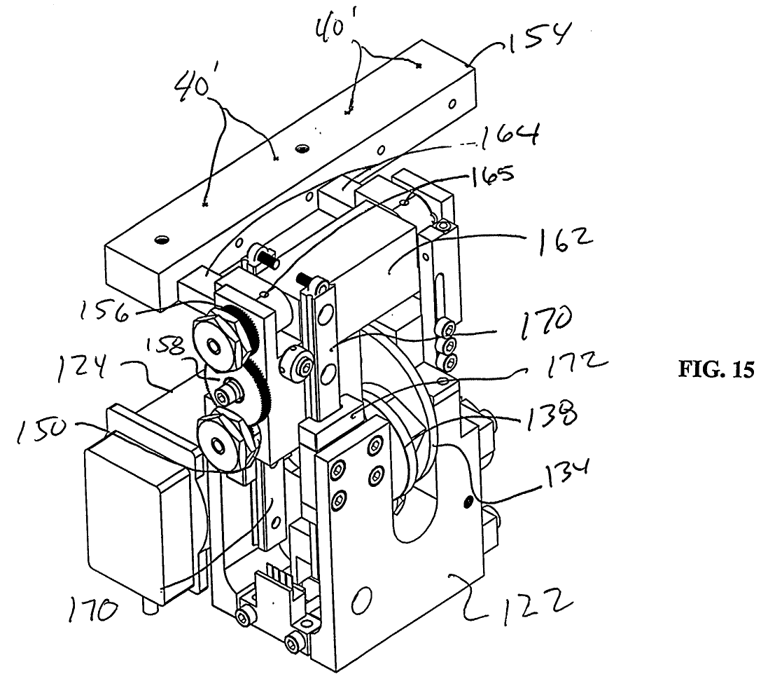

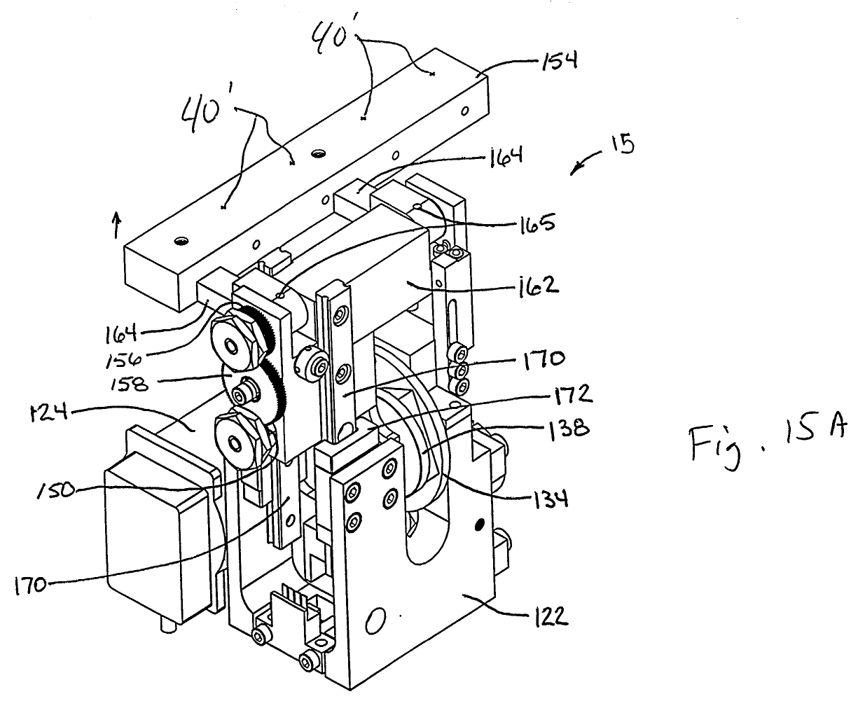

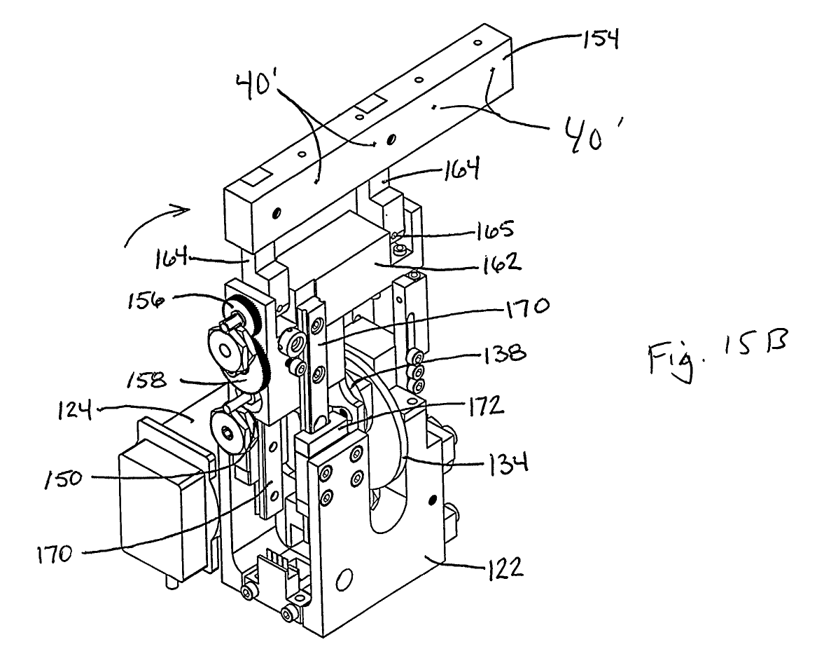

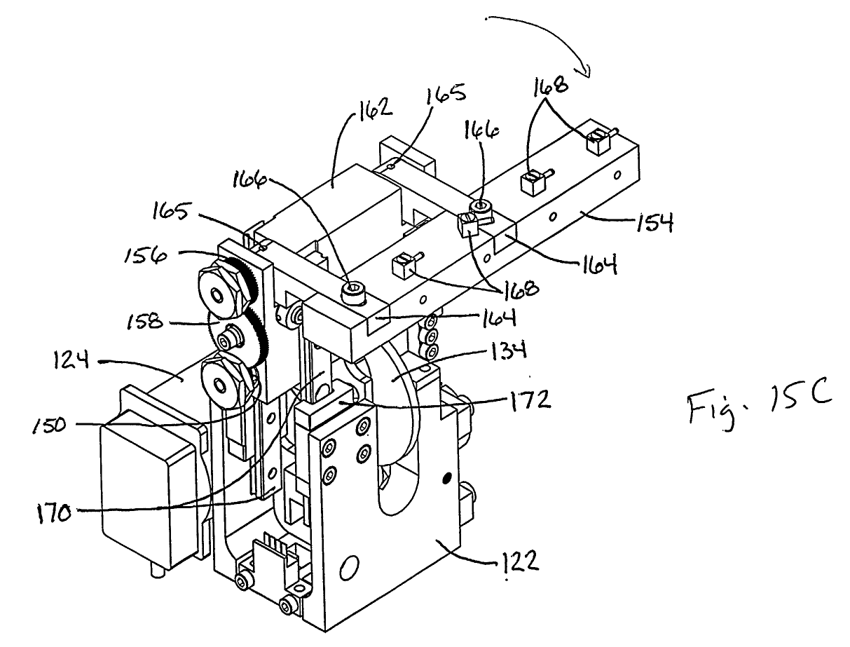

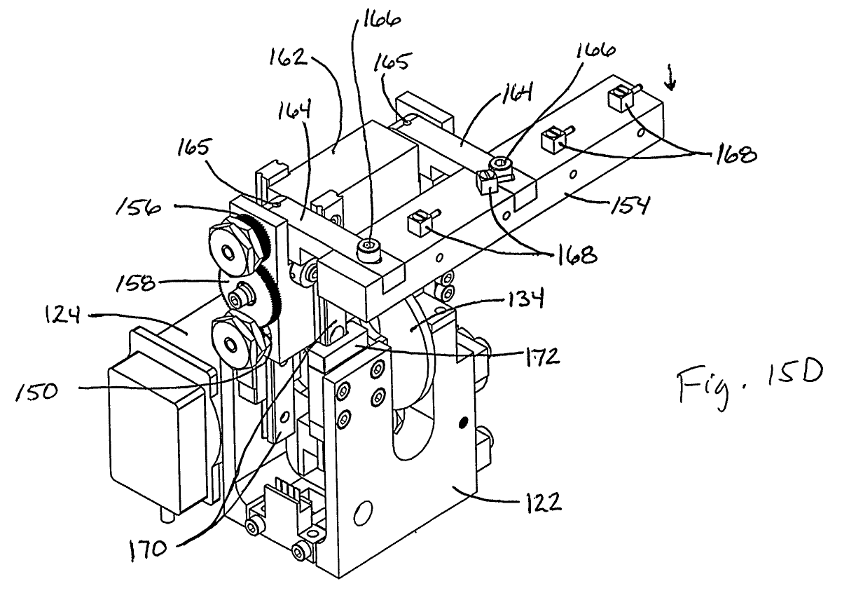

As with the first and second shuttle platforms 34, 36, at least one preferably a plurality of spaced apart electronic components storage locations 40′ (FIGS. 15, 15A and 15B) are provided on a top surface of the inverter platform 154, with each storage location 40′ capable of temporarily storing one electronic component 22 thereon for later retrieval by the shuttle platform 34 or 36. It is to be appreciated that the number, the location and or the spacing of the electronic component storage locations 40′, along a top surface of the inverter platform 154, can vary from application to application and can be readily modified as necessary by one skilled in the art. Each one of the electronic component storage locations 40′ is provided with at least one suction hole (not separately numbered) to facilitate support and retention of the temporary placed and stored electronic component 22 thereon. According to a preferred form of the invention, a separate suction source is coupled to each one of the electronic component storage locations 40′, by a flexible plastic tubing and the respective vacuum coupling 168, and each separate suction source is separately controlled by the computer 32. Alternatively, all of the electronic storage locations 40′ can be connected to a single suction source which is simultaneously activated and deactivated by the computer 32. The computer 32 activates the vacuum applied to a desired one of the electronic storage locations, once the vacuum source 28 applied by the collet pick-up assembly 26 is discontinued, so as to securely retain and temporarily store the transported electronic component 22 on the top surface of the inverter platform 154 for later transfer to either the first or second shuttle platform 34 or 36.

A pair of opposed inwardly facing inverter tracks 170 (FIGS. 14A, 15, 15A and 15B) are provided on the inverter housing 122 to facilitate a desired reciprocating motion of the inverter shuttle 162, supporting the inverter platform 154, relative to the inverter housing 122. The inverter assembly 162 carries a pair of mating outwardly facing inverter guides 172 which are located to matingly engage with the inverter tracks 170. The mating engagement between the inverter guides 172 and the inverter tracks 170 facilitates vertical upward and downward movement of the inverter shuttle 162, along with the supported inverter platform 154, relative to the inverter housing 122. To captively retain the inverter shuttle 162 in an operative position with respect to the inverter housing 122, e.g. maintain the third and fourth toothed gears 138 and 148 in constant meshing engagement with one another, during the inverting motion of the inverter assembly 15, one end of a limiter member 174 (FIG. 14A) is pivotably connected to an end of the clutch member 152 supporting the fourth toothed gear 148. The limiter member 174 allows vertical and horizontal motion with respect to the inverter housing 122 while still retaining the third and fourth toothed gears 138 and 148 in constant meshing engagement with one another.

With reference now to FIG. 16 and 16A, a detail description of the clutch member 152 will now be provided. The clutch member 152 comprises separate first and second axially aligned shafts 175, 176. The first shaft 175 supports a movable flange 177 having a pair of gradually inclined V-shaped ramp surfaces 178 formed on a front face thereof. The second shaft 176 supports a stationary flange 177′ having a pair of gradually inclined V-shaped ramp surfaces 178 formed on a front face thereof. A pair of ball bearings 180 are captively located between the pair of V-shaped ramp surfaces 178 of the movable and stationary flanges 177, 177′. A compression spring 182 is supported by the first axially aligned shaft 175 and a first end of the compression spring 182 engages with a stop member 184 supported by an intermediate area of the first axially aligned shaft 175. A second opposed end of the compression spring 182 engages with a rear face of a movable flange 177 to bias the movable flange 177 toward the stationary flange 177′ and constantly compress the pair of ball bearings 180 between the pair of V-shaped ramp surfaces 178 of the flanges 177, 177′. Due to this arrangement, it is to be appreciated that the first and second axially aligned shafts 175, 176 generally rotate together with one another during an intermediate range of movement but the first axially aligned shaft 175 is capable of rotating with respect to the second axially aligned shaft 176 at opposite ends of their range of movement.

Due to the arrangement of the clutch member 152, during a majority of the rotation of the clutch member 152, the clutch member 152 directly transfers the drive received from the fourth toothed gear 148 to the first inverter gear 150. However, when the inverter arms 164 abut against a surface of the inverter shuttle 162, once the inverter platform 154 has rotated precisely 180° with respect to the inverter shuttle 162, further pivoting or rotation of the inverter platform 154, with respect to the inverter shuttle 162, is no longer permitted. Accordingly, any further rotation of the fourth toothed gear 148 is taken up or absorbed by the clutch member 152 while the first inverted gear 150 remains stationery and does not rotate any further.

As the fourth toothed gear 148 continues rotates relative to the first inverter gear 150, the ball bearings 180 roll along the inclined ramp surfaces 178 of the two mating flanges 177, 177′ and such rolling motion of the ball bearings 180 forces the movable flange 177 away from the stationary first flange 177′. Such motion of the ball bearings 180 along the inclined ramp surfaces 178 of the flanges 177, 177′ compresses the spring 182 but still allows the inverter motor 124 to continue rotating the first though the fourth toothed gears 132, 134, 138 and 148 over a limited range of motion. Since the inverter platform 154 is inhibited from rotating in excess of 180° with respect to the inverter shuttle 162, the further limited rotation of the inverter motor 124 only permits vertical upward or downward movement of the inverter platform 154, relative to the inverter housing 122, depending upon the rotational direction, e.g. only allows vertical upward movement of the inverter assembly 162 relative to the invert housing 122 from the position shown in FIG. 15 to the position shown in FIG. 15A or vertically downward movement from the position shown in FIG. 15C to the position shown in 15D. Such further rotation of the inverter motor 124 facilitates exclusively vertical movement of the inverter shuttle 162, with respect to the inverter housing 122, without providing any pivoting movement of the inverter platform 154 with respect to the inverter housing 122. The exclusively vertical movement of the inverter platform 154 only occurs when the fourth tooth gear 148 begins to rotate or terminates rotation. The exclusively vertical movement of the inverter platform 154 is important to facilitate compensation for the thickness of the electronic component 22 carried by the inverter platform 154 and ensure that the electronic component 22 is completely inverted a full 180 degrees-not inverted a lesser amount.

It is desirable to located the inverter platform 154 at exactly the same horizontal height as the first or second shuttle platform 34, 36 so that the collet pick-up assembly 26 can be programmed to easily place the retrieved electronic component 22 on either the inverter assembly 15, if inversion of the electronic component 22 is necessary, or conveyed a further distance, along the Y-axis, to place the retrieved electronic component directly on either the first or second shuttle platforms 34, 36 without inversion.

If the inverter assembly 15 was not provided with any vertical movement, it could be difficult to invert or flip over the electronic component 22 precisely 180° as the thickness of the electronic component 22 (which could range between 4 mils to 3/16 of an inch) may interfere with inverting or flipping the electronic component completely 180° by the inverter platform 154 with respect to the first or second shuttle platform 34, 36. Accordingly, it is desirable to have an initial vertical upward movement of the inverter platform (FIG. 15 to FIG. 15A) before commencing any pivoting or rotating the inverter platform 154 and also terminate with a vertical downward movement (FIG. 15C to FIG. 15D), following completion of the 180° inversion process of the inverter platform 154, to facilitate a gentle lowering or placement of the electronic component 22 on either the first or the second shuttle platform 34, 36.

Once the inverter platform 154 is in a desired orientation or position located directly over the first or the second shuttle platform 34, 36, the vacuum source supplied to the inverter platform 154 is discontinued and simultaneously therewith, or slightly prior thereto, a vacuum is applied to the first or the second shuttle platform 34, 36 to facilitate retention of the electronic components 22 transferred by the inverter platform 154. To facilitate release of the electronic components 22 from the inverter platform 154, a small pulse or blast of air may be applied by the vacuum source of the invert platform 154 to facilitate release of the electronic components 22 from the inverter platform 154.

Once the electronic components 22 are transferred by the inverter platform 154 to either the first or the second shuttle platform 34, 36, the sequence of the inverter platform 154 is reversed so that the inverter platform 154 is again returned back to its initial position (FIG. 15) to receive an additional supply of electronic components 22 from the pick and place assembly 16 and the substantially continuous retrieval and transfer of electronic components 22 to either the first or the second shuttle platform 34, 36 is repeated as necessary.

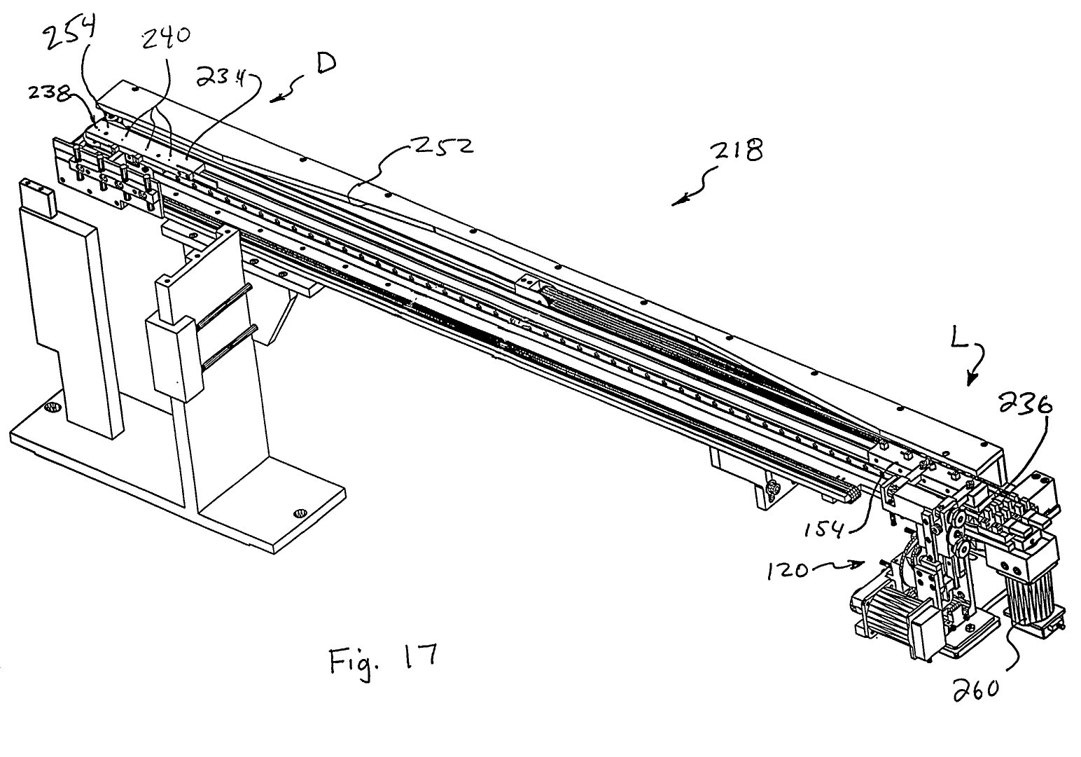

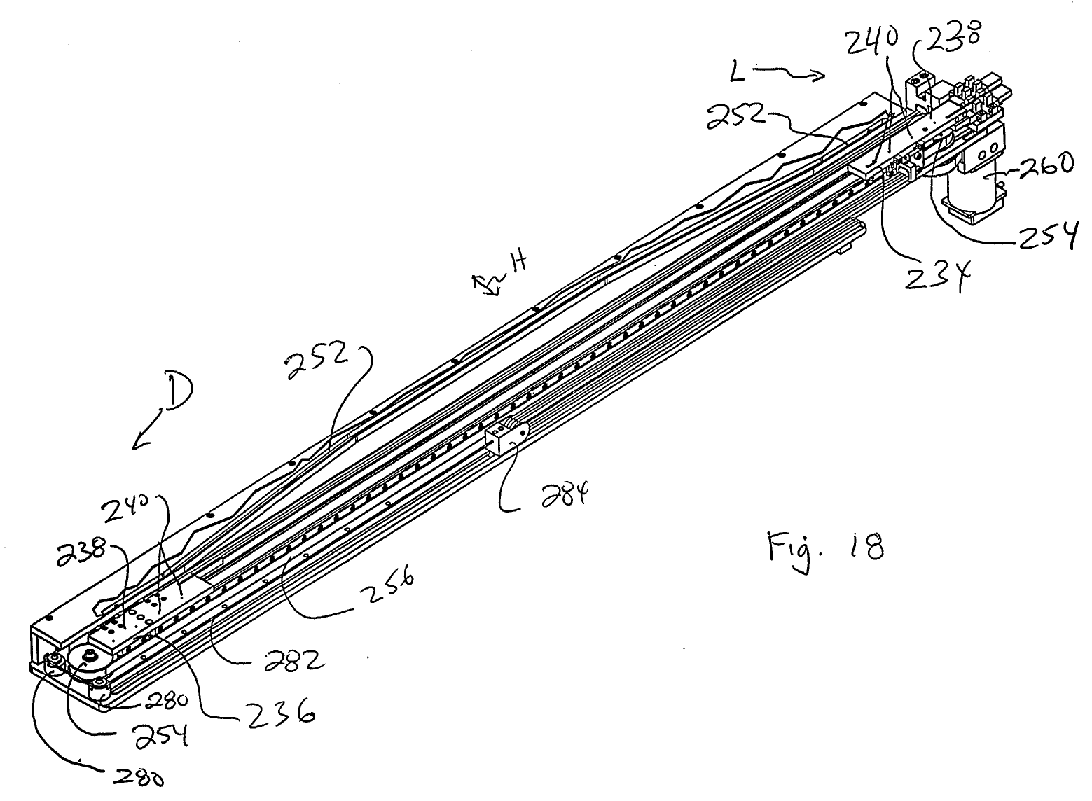

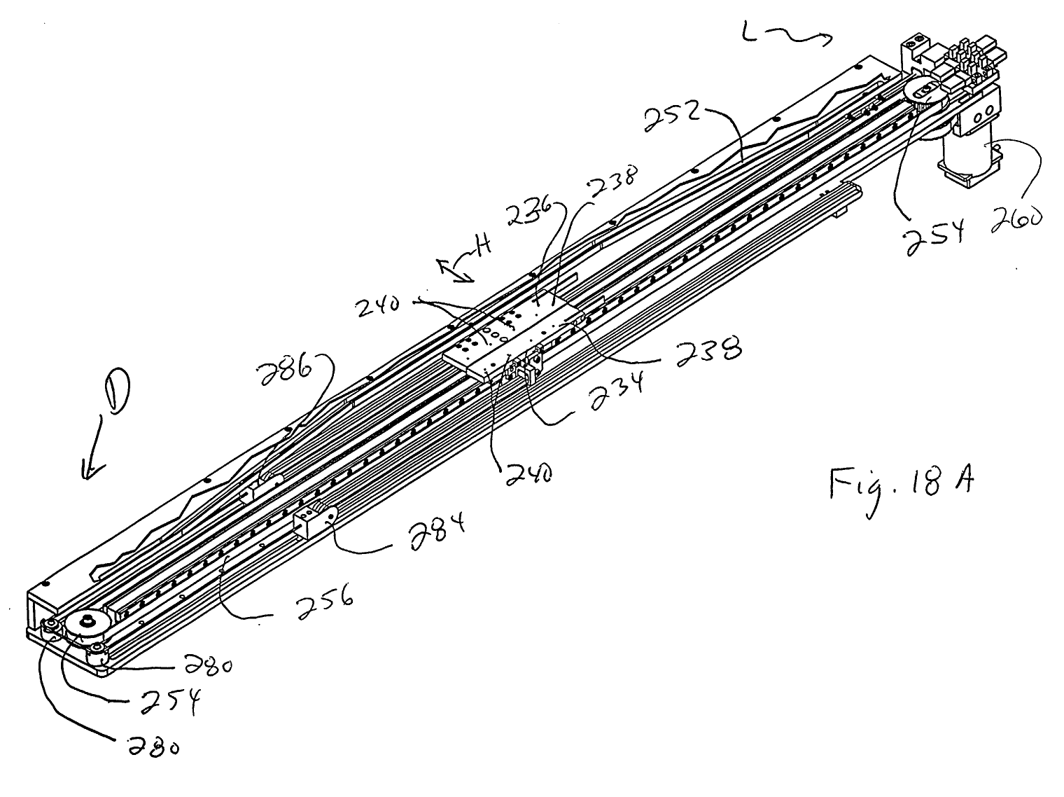

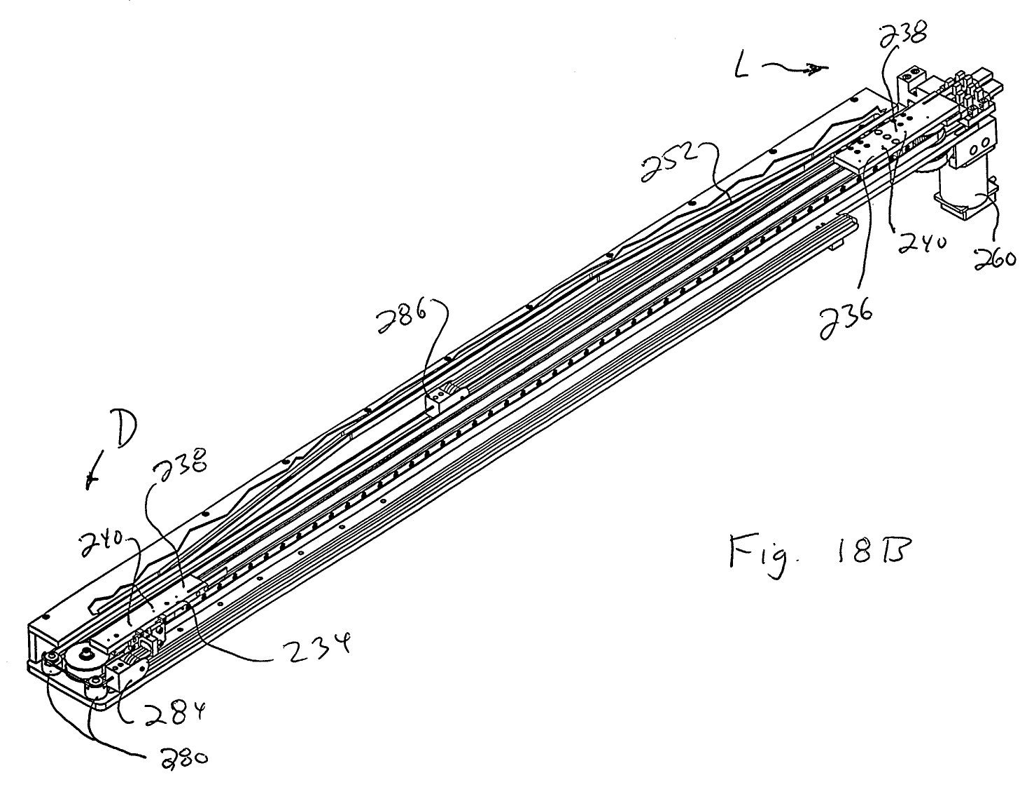

With reference now to FIGS. 17-18C, a second embodiment of the shuttle assembly 218, according to the present invention, will now be discussed. According to this embodiment, each of the first and second shuttle platforms 234, 236 has at least one spaced apart electronic component storage locations 240 each capable of temporarily storing one electronic component 22 thereon for later retrieval by the automated assembly apparatus. It is to be appreciated that the number, the location and/or the spacing of the electronic component storage locations 240, along the top surface 238 of both of the first and the second shuttle platforms 234, 236 can vary from application to application and can be modified as necessary as would be apparent to those skilled in this art. Each one of the electronic component storage locations 240 is provided with at least one suction hole (not separately numbered), preferably a plurality of suction holes are formed in the top surface 238 of the first and the second shuttle platforms 234, 236 to facilitate support and retention of the placed and temporarily stored electronic component 22 thereon. In a preferred form of the invention, a separate suction source (not shown) is coupled to the suction hole(s) of each one of the electronic component storage locations 240, by flexible tubing (not labeled), and each separate suction source is separately controlled by the computer 32. The computer 32 activates the vacuum for a desired one of the electronic component storage locations 240 once the vacuum source, applied to the collet pick-up assembly 26, is discontinued so as to securely retain and temporarily store the transported electronic component 22 on the top surface 238 of either the first or the second shuttle platform 234 or 236 for later retrieval of the electronic component 22, by the automated assembly apparatus, once the shuttle platform 234 or 236 is later transported and located at the dispensing location D.

When assembly of one of the transported electronic components 22, currently located at the dispensing position D, is desired by the automated assembly apparatus, the automated assembly apparatus is programmed, in a conventional manner, to retrieve that desired electronic component 22 at substantially the same time that the computer 32 discontinues the supply of vacuum to the corresponding electronic component storage location 240 so that temporarily stored electronic component 22 can be readily retrieved by the automated assembly apparatus for production purposes. To facilitate operation of the shuttle assembly 218, it is imperative that the top surfaces 238 and the electronic components storage locations 240 of the first and second shuttle platforms 234, 236 occupy substantially identical positions, whether in the loading position L or in the dispensing position D, so that the automated feed mechanism 2 and the automated assembly apparatus are not effected by which one of the two shuttle platforms is receiving or dispensing electronic components 22.

As both the first and the second shuttle platforms 234, 236 are similar to one another, first a detailed description with respect to the first shuffle platform 234 will be provided and this will be followed by a detailed description concerning the differences of the second shuttle platform 236.

The first shuttle platform 234 is aligned along the shuttle path and is provided with a conventional first guide and bearing mechanism. A first guide and bearing mechanism (not shown in detail) allows the first shuttle platform 234 to be conveyed back and forth, in a reciprocating fashion, along the shuttle assembly 218. The first shuttle platform 234 is securely fastened to the guide and bearing mechanism and moves to and fro along the X-axis along with the first guide and bearing mechanism. The first shuttle platform 234 extends perpendicular to the sidewalls 6 of the support frame 4 and is conveyed in a direction horizontally perpendicular to the sidewalls 6, i.e. conveyed along the X-axis.

The second shuttle platform 236 is mounted in a somewhat similar manner and extends and moves in substantially the same direction as the first shuttle platform 234, i.e. the second shuttle platform 236 also extends perpendicular to the sidewalls 6 and is conveyed in a direction horizontally perpendicular to the sidewalls 6. However, the second shuttle platform 236, when moving from a dispensing position D, located remote from the input table/loader assembly and adjacent a retrieval station of the automated assembly apparatus 3 (the left side position as seen in FIGS. 17-18C), to a loading position L, located adjacent the input table/loader assembly (the right side position as seen in FIGS. 17-18B), also moves horizontally radially outward (in the direction of arrow H) and then horizontally back radially inward along the Y-axis, extending parallel side walls 6, to facilitate a gentle and gradual sideways motion of the second shuttle platform 236 with respect to the first shuttle platform 234 (FIGS. 18, 18A and 18B) and passage of the first and the second shuttle platforms 234, 236 side by side past one another as they each move to the other of the loading and the dispensing positions L or D without abutting or interfering with one another or the carried electronic components 22 (FIG. 18A).

As the second shuttle platform 236 approaches either the loading or the dispensing position L or D, the second shuttle platform 236 gradually moves back horizontally radially inward so as to occupy substantially the same position occupied by the first shuttle platform 234 when in that same position. That is, the position of the top surface 238 of the first shuttle platform 234, when in the loading position L, is identical to the position of the top surface 238 occupied by the second shuttle platform 236 when in the loading position L, and the position of the top surface 238 of the first shuttle platform 234, when in the dispensing position D, is substantially identical to the position of the top surface 238 occupied by the second shuttle platform 236 when in the dispensing position D. This feature facilitates uniform placement of the electronic components 22 on either the first or the second support platform 234 or 236, when located at the loading position L, as well as uniform retrieval of the electronic components 22, from either the first or the second shuttle platforms 234 or 236, when located at the dispensing position D.

To facilitate the gentle side stepping of the second shuttle platform 236 along the Y-axis, a side step guide track 252 is formed on an undersurface of the guide rail 248 of the shuttle assembly 218. The side step guide track 252 is a somewhat curved or radius track to facilitate a gradual side stepping of the second shuttle platform 236 as the second shuttle platform 236 is conveyed from one of the loading or dispensing position L or D to the other of the loading or dispensing position D or L.

The second shuttle platform 236 is provided with a second guide and bearing mechanism (not shown in detail) which allows the second shuttle platform 236 to be conveyed back and forth, in a reciprocating fashion along the shuttle assembly 218. As the second shuttle platform 236 is conveyed from one of loading and dispensing positions L or D to the other of the loading and dispensing positions, the curvature of the second guide track 252 gently side steps the second shuttle platform 236 by a sufficient distance (FIG. 18A), e.g. a distance of about 0.785 inch or so, to provide suitable clearance between the first and the second shuttle platforms 234, 236 as they pass by one another. A bearing arrangement facilitates the sideward or radial movement of the second shuttle assembly 236.

The guide rail also supports a pair of spaced apart end rollers 254, one located adjacent the loading position L and the other located adjacent the dispensing position D of the shuttle assembly 218, and an endless belt 256 is wrapped around the pair of spaced apart rollers 254. A portion of the first shuttle platform 234 is coupled or clamped (not shown), in a conventional manner, to a first section of the endless belt 256 when the first shuttle platform 234 is in one of the loading and dispensing positions L or D, while a portion of the second shuttle platform 236 is coupled or clamped (not shown), in a conventional manner, to an opposed section of the endless belt 256 when the second shuttle platform 236 is in the other of the loading and dispensing positions L or D. By this arrangement, as the endless belt 256 is driven by a shuttle motor or drive 260 in a first direction, e.g. counterclockwise as seen in FIG. 18, the first and the second shuttle platforms 234, 236 initially move toward one another and, once the second shuttle platform 236 is side stepped and passes by the first shuttle platform 234 (FIG. 18A), the two shuttle platforms then move away from one another until they reach their other end position (FIG. 18B) where the electronic components can be removed from the first shuttle platform 234.

If the endless belt 256 is now driven in a reverse direction by shuttle motor or drive 260, e.g. rotated clockwise, the two shuttle platforms 234, 236 again initially move toward one another and once the second shuttle platform 236 again side steps the first shuttle platform 234 (FIG. 18A), then the two shuttle platforms 234, 236 move away from one another until they reach their previous end positions (FIG. 18).

Such conveying motion of the first and the second shuttle platforms 234, 236, of the shuttle assembly 18, facilitates transfer of one of the first and second shuttle platforms 234 or 236, which was just loaded with electronic components by the automated feed mechanism, from the loading position L to the dispensing position D, adjacent the automated assembly apparatus, so that those loaded individual electronic components can be retrieved and assembled into a desired product by the automated assembly apparatus. Simultaneously therewith, the other of the first and second shuttle platforms 236 or 234, which was just emptied of electronic components by the automated assembly apparatus 3, is transferred to the loading position L, adjacent the automated feed mechanism 2, so that additional electronic components can be loaded thereon by the pick and place assembly 16.

Once all of the electronic components are retrieved from the shuttle platform 234 or 236 located at the dispensing position D, adjacent the automated assembly apparatus, and once additional electronic components are loaded on the shuttle platform 236 or 234 located at the loading position L, adjacent the automated feed mechanism, the shuttle motor or drive 260 is reversed so that the shuttle platform 234 or 236, at the loading position L is reconveyed back to the dispensing position D while the shuttle platform 236 or 234 at the dispensing position D is simultaneously reconveyed back to the loading position L. This operation is repeated through the production sequence of the automated feed mechanism 2.

The guide rail also supports a pair of spaced apart rollers 280 both located adjacent the dispensing position D of the shuttle assembly 218. A fixed length cable 282 is wrapped around the pair of spaced apart rollers 280. One end of the fixed length cable 282 is connected to a first pulley housing 284 supporting a first plurality of rotatable pulleys and a second end of the fixed length cable 282 is connected to a second pulley housing 286 supporting a second plurality of rotatable pulleys. The flexible plastic tubing, providing vacuum to the electronic storage locations 240 formed in the top surface of the first shuttle platforms 234, each wrap around one of the first plurality of rotatable pulleys supported by the first pulley housing 284 while the flexible plastic tubing, providing vacuum to the electronic storage locations 240 formed in the top surface of the second shuttle platform 236, each wrap around one of the second plurality of rotatable pulleys supported by the second pulley housing 286. Due to this arrangement, as the first and second shuttle platforms 234, 236 are conveyed from the loading to the dispensing locations L or D, and vice versa, the movement of the first and second shuttle platforms 234, 236 exert a sufficient tension on the respective flexible plastic tubings which induces the first and second pulley housings 284, 286 to move oppositely in unison with other another and maintain a sufficient tension on the respective flexible plastic tubing to prevent the flexible plastic tubing from hindering the necessary movement of the first and second shuttle platforms 234, 236.

Since certain changes may be made in the above described improved automated feed mechanism, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, we claim:

1. An automated feed mechanism for supplying electronic components via a shuttle assembly, the automatic feed mechanism comprising:
a support frame; and
a pick and place assembly being supported by the support frame for retrieving electronic components from a desired wafer assembly and for transporting each retrieved electronic component to a shuttle assembly supported by the support frame;
wherein the shuttle assembly comprises first and second shuttle platforms that are simultaneously movable with one another such that when one of the first and second shuttle platforms is moved from a loading position, located adjacent the pick and place assembly for loading of an electronic component, to a dispensing position located remote from the pick and place assembly for removal of the loaded electronic component, the other of the first and second shuttle platforms is moved from the dispensing position to the loading position.

2. The automatic feed mechanism according to claim 1, wherein the automatic feed mechanism further includes a table/loader assembly supported by the support frame for retrieving a desired wafer assembly from a wafer assembly magazine which stores a plurality of wafer assemblies therein, the wafer assembly magazine is supported on an elevator assembly, and the elevator assembly has an elevator drive mechanism to move of the elevator assembly and facilitate retrieval of the desired wafer assembly from wafer assembly magazine.

3. The automatic feed mechanism according to claim 1, wherein the first and the second shuttle platforms are provided with a drive mechanism so that when the first shuttle platform is conveyed from one of the loading and the dispensing positions to the other of the loading and the dispensing positions, the second shuttle platform is simultaneously conveyed to the position previously occupied by the first shuttle platform.

4. The automatic feed mechanism according to claim 3, wherein as the second shuttle platform is conveyed from one of the loading and the dispensing positions to the other of the loading and the dispensing positions, the second shuttle platform is initially lowered, during such conveying motion, so the second shuttle platform passes underneath the first shuttle platform and then the second shuttle platform gradually rises so as to occupy a substantially identical position which was occupied by the first shuttle platform.

5. The automatic feed mechanism according to claim 3, wherein the drive mechanism for the first and second shuttle platforms comprises a motor coupled to drive an endless belt, and the first and the second shuttle platforms are each coupled to the endless belt such that rotation of the endless belt in one direction conveys the first and second shuttle platforms to one of the loading and the dispensing positions, and rotation of the endless belt in the opposite direction conveys the first and second shuttle platforms to the other of the loading and the dispensing positions.

6. The automatic feed mechanism according to claim 1, wherein each one of the first and second shuttle platforms is provided with a plurality of component storage locations, on a top surface thereof, and each one of the component storage locations has at least one aperture coupled to a vacuum source to facilitate releasably securing of the electronic component at the component storage location, via vacuum applied by the vacuum source, following placement of the electronic component thereon by the pick and place assembly.

7. The automatic feed mechanism according to claim 4, wherein the first shuttle platform is guided by a first guiding bearing mechanism which includes a linear track and the second shuttle platform is guided a second guide bearing mechanism which includes a pair of tracks, one of the pair of tracks is linear and the other of the pair of tracks is curved to facilitate the gradual lowering and raising of the second shuttle platform as the second shuttle platform moves from one of the loading and the dispensing positions to the other the loading and the dispensing positions.

8. The automatic feed mechanism according to claim 2, wherein the input table/loader assembly comprises a lower table having a central circular opening therein supporting a cylindrical ring and an upper table which is movable relative to the lower table, and a table movement mechanism for facilitating vertical movement of the upper table relative to the lower table to facilitate sandwiching of the desired wafer assembly between the upper table and the cylindrical ring.

9. The automatic feed mechanism according to claim 8, wherein the upper table further comprises a loader catch which is movable from a retracted position, located remote from the elevator assembly, to an extended position, located adjacent the elevator assembly, to facilitate return of a desired wafer assembly and retrieval of a new wafer assembly, from the wafer assembly magazine, for supplying a new wafer assembly to the input table/loader assembly to facilitate retrieval of additional electronic components therefrom.

10. The automatic feed mechanism according to claim 9, wherein the loader catch comprises a pair of mating jaws with a drive mechanism for opening and closing the pair of mating jaws to facilitate engagement and disengagement of a desired wafer assembly via the pair of mating jaws, the drive mechanism facilitates release of one wafer assembly and retrieval of a second wafer assembly for conveyance of a new wafer assembly to the input table/loader assembly for retrieval of additional electronic components.

11. The automatic feed mechanism according to claim 9, wherein the input table/loader assembly comprises a movable table platform which facilitates movement of the input table/loader assembly from a location adjacent the elevator assembly to a location remote from the elevator assembly and the movable table platform further includes a drive mechanism to facilitate rotation of the upper table and the lower table, relative to the movable table platform, to compensate for any minor misalignment of the wafer assembly supported by the input table/loader assembly and facilitate proper retrieval of additional electronic components from the wafer assembly.

12. The automatic feed mechanism according to claim 2, wherein the wafer assembly magazine has a plurality of shelves, and each shelf is capable of supporting one wafer assembly thereon in a vertical spaced relationship with respect to other supported wafer assemblies, and the elevator drive mechanism one of raises and lowers the wafer assembly magazine, along a Z-axis, to facilitate one of raising and lowering of the wafer assembly magazine relative to a loader catch to assist with one of release of a returned wafer assembly and retrieval of a new wafer assembly for conveyance to the input table/loader assembly for retrieval of additional electronic components.

13. The automatic feed mechanism according to claim 2, wherein the pick and place assembly includes a collet pick-up assembly, coupled to a vacuum source, to facilitate retrieval of the electronic component from the wafer assembly supported by the table/loader assembly and conveyance of that electronic component to the shuttle assembly, and the die elevation assembly and the collet pick-up assembly work in unison with one another to facilitate retrieval of a desired electronic component from a wafer assembly supported by the table/loader assembly.

14. The automatic feed mechanism according to claim 13, wherein the automatic feed mechanism further comprises a machine vision camera for viewing operation of the collet pick-up assembly, the die elevation assembly, and the table/loader assembly, and the machine vision camera, the collet pick-up assembly, the die elevation assembly, and the table/loader assembly are all coupled to a computer which controls operation of the automated feed mechanism.

15. The automated feed mechanism according to claim 1, wherein the second shuttle platform includes a shuttle bypass mechanism to facilitate vertically lowering and raising of the second platform, relative to the first platform, as the second platform is shuttled from the loading position to the dispensing, and also facilitate vertically lowering and raising of the second platform, relative to the first platform, as the second platform is shuttled from the dispensing position to the loading position.

16. The automated feed mechanism according to claim 1, wherein the second shuttle platform includes a shuttle bypass mechanism to facilitate horizontal movement of the second platform, relative to the first platform, as the second platform is shuttled from the loading position to the dispensing position, and also facilitate horizontal movement of the second platform, relative to the first platform, as the second platform is shuttled from the dispensing position to the loading position.

17. The automated feed mechanism according to claim 1, wherein an inverter assembly is positioned between the pick and place assembly and the shuttle assembly, and the inverter assembly receives at least one electronic component from the pick and place assembly and facilitates inverting of the at least one electronic component, received from the pick and place assembly, when transferring the at least one electronic component to the shuttle assembly.

18. The automated feed assembly according to claim 17, wherein the inverter assembly includes an inverter platform which receives and supports the at least one electronic component received from the pick and place assembly, and the inverter platform includes a raising/pivoting mechanism for raising the inverter platform vertically, when transferring the at least one electronic component to the shuttle assembly, prior to commencing an inverting motion of the inverter platform.

19. An automated feed mechanism for a feeding wafer assembly, the automatic feed mechanism comprising:
a support fame;
a table/loader assembly being supported by the support frame for supporting a desired wafer assembly; and
a pick and place assembly supported by the support frame means for retrieving at least one electronic component, from a supported wafer assembly and transporting the at least one retrieved electronic component to a shuttle assembly supported by the support frame;
wherein the shuttle assembly comprises first and second shuttle platforms that are simultaneously movable with one another such that when one of the first and second shuttle platforms is moved from a loading position, located adjacent the pick and place assembly for loading of the at least one electronic component thereof, to a dispensing position located remote from the pick and place assembly for removal of the at least one loaded electronic component, the other of the first and second shuttle platforms is moved from the dispensing position to the loading position.

20. A method of automatically feeding a wafer assembly via a automatic feed mechanism, the method comprising the steps of
providing a support frame;
supporting a table/loader assembly, for supporting a desired wafer assembly, on the support frame;
supporting a pick and place assembly on the support frame for retrieving at least one electronic component from a supported wafer assembly and transporting each retrieved electronic component to a shuttle assembly supported by the support frame;
forming the shuttle platform from the first and second shuttle platforms; and
simultaneously moving the first and second shuttle platforms with one another such that when one of the first and second shuttle platforms is moved from a loading position, located adjacent the pick and place assembly for loading of the at least one electronic component thereon, to a dispensing position located remote from the pick and place assembly for removal of the loaded electronic component, the other of the first and second shuttle platforms is moved from the dispensing position to the loading position.
